(19) United States
(12) Patent Application Publication
(10) Pub. No.: US 2005/0026058 A1
(43) Pub. Date: Feb. 3, 2005

(54) Electrophotographic photoreceptor, and electrophotographic image forming apparatus and process cartridge using the electrophotographic photoreceptor

(76) Inventors: Hidetoshi Kami, Numazu-shi (JP); Shinji Nousho, Numazu-shi (JP); Takaaki Ikegami, Susono-shi (JP); Eiji Kurimoto, Numazu-shi (JP); Hideo Nakamori, Numazu-shi (JP); Akihiro Sugino, Numazu-shi (JP); Yasuyuki Yamashita, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/900,204

(22) Filed: Jul. 28, 2004

(30) Foreign Application Priority Data
Jul. 31, 2003 (JP) 2003-204333
Jun. 21, 2004 (JP) 2004-182287

(51) Int. Cl. G03G 5/047; G03G 5/147

(52) U.S. Cl. 430/66; 430/59.6; 430/60; 430/58.7; 430/132

(57) ABSTRACT

An electrophotographic photoreceptor including an electroconductive substrate; a photosensitive layer overlying the electroconductive substrate optionally via an undercoat layer; and optionally a protective layer overlying the photosensitive layer, wherein an outermost layer of the electrophotographic photoreceptor comprises a binder resin; a particulate fluorine-containing resin in an amount of from 20 to 70% by volume based on total volume of the outermost layer, wherein a surface free energy of the particulate fluorine-containing resin is larger than a surface free energy of the binder resin; and a fluorochemical surfactant in an amount of from 5 to 70% by weight based on total weight of the binder resin.

### BACKGROUND OF THE INVENTION

1. Field of the Invention

The present invention relates to an electrophotographic photoreceptor, and an electrophotographic image forming apparatus and a process cartridge using the electrophotographic photoreceptor.

2. Discussion of the Background

An inorganic photoreceptor formed from selenium, zinc oxide or cadmium sulfate was mostly used as an electrophotographic photoreceptor for use in an electrophotographic image forming apparatus applicable to a copier and a laser printer, and now an organic photoreceptor is more widely used than the inorganic photoreceptor because of less damaging the global environment, its low cost and design freedom.

The organic photoreceptor is classified to (1) a uniform single-layered photoreceptor wherein a photoconductive resin typified by polyvinylcarbazole (PVK) or a charge transfer complex typified by PVK-TNF (2,4,7-trinitrofluorenone) is formed on an electroconductive substrate; (2) a dispersion single-layered photoreceptor wherein a resin including a dispersed pigment such as phthalocyanine and perylene is formed on an electroconductive substrate; and (3) a multilayered photoreceptor wherein a photosensitive layer formed on an electroconductive substrate is functionally separated to a charge generation layer (CGL) including a charge generation material such as an azo pigment and a charge transport layer (CTL) including a charge transport material such as triphenylamine.

The multilayered photoreceptor includes a photoreceptor including a CTL on a CGL and a photoreceptor including a CGL on a CTL. The former is typically used and the latter is occasionally called a reversely-layered photoreceptor. Particularly, the multilayered photoreceptor has an advantage of having higher sensitivity and design freedom for higher sensitivity and durability. Therefore, most of the organic photoreceptors are multilayered.

As an importance of manufacturing in consideration of global environmental protection increases recently, a photoreceptor is required to change to a machine part from a supply product (a disposable product). Therefore, the photoreceptor needs to have a long life and a protective layer is typically formed on a photosensitive layer thereof.

As a toner for developing in electrophotography, a polymerized toner, a spheric toner and a toner having a small particle diameter (approximately 6 μm or less) are mostly used to less damage the global environment when the toner is produced and to produce high-quality images. The photoreceptor is desired to have a low surface friction coefficient and maintain the low surface friction coefficient even after repeated use to have cleanability for these toners and reuse a residual toner after development.

It is known that a photoreceptor having a surface applied with a lubricant such as zinc stearate to lower a friction coefficient thereof (hereinafter referred to as a low surface energization) has cleanability for the polymerized toner.

However, when a lubricant is externally applied to a surface of a photoreceptor, the lubricant is mixed in a recycled toner, resulting in deterioration of the toner.

As other means, Japanese Laid-Open Patent Publications Nos. 11-218953 and 11-272003 disclose means of including a lubricant such as a silicone compound, a particulate fluorine-containing resin and a fatty ester in an outermost layer of a photoreceptor, particularly means of including a particulate fluorine-containing resin therein to improve cleanability for a polymerized toner.

The particulate fluorine-containing resin is effectively included in a surface of the photoreceptor for the low surface energization thereof. However, a friction coefficient of the surface of the photoreceptor increases as repeatedly used for long periods and an initial low friction coefficient is difficult to maintain only by including the particulate fluorine-containing resin in the surface of the photoreceptor. A surface friction coefficient of a photoreceptor including the particulate fluorine-containing resin increases before long after starting using the photoreceptor and has insufficient cleanability, and therefore the photoreceptor has to be exchanged.

In addition, the surface of the photoreceptor has to include a predetermined concentration or more of the particulate fluorine-containing resin, and a surface layer thereof becomes fragile as Japanese Laid-Open Patent Publications Nos. 7-13381 (paragraph [0013]) and 10-142816 (paragraph [0026]) disclose. Further, even when a photoreceptor includes a specified amount of the particulate fluorine-containing resin, abrasion resistance thereof deteriorates in many cases.

Because of these reasons, a need exists for an electrophotographic photoreceptor having a high abrasion resistance and a low surface friction, which are persistent.

### SUMMARY OF THE INVENTION

Accordingly, an object of the present invention is to provide an electrophotographic photoreceptor having both high abrasion resistance and a low surface friction, which are persistent even after repeatedly used for long periods.

Another object of the present invention is to provide a process cartridge and an image forming apparatus using the electrophotographic photoreceptor.

Briefly these objects and other objects of the present invention as hereinafter will become more readily apparent can be attained by an electrophotographic photoreceptor including an electroconductive substrate; a photosensitive layer overlying the electroconductive substrate optionally via an undercoat layer; and optionally a protective layer overlying the photosensitive layer, wherein an outermost layer of the electrophotographic photoreceptor includes a binder resin; a particulate fluorine-containing resin in an amount of from 20 to 70% by volume based on total volume of the outermost layer, wherein a surface free energy of the particulate fluorine-containing resin is larger than a surface free energy of the binder resin; and a fluorochemical surfactant in an amount of from 5 to 70% by weight based on total weight of the binder resin.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating a partial cross-section of an embodiment of the electrophotographic image forming apparatus of the present invention;

FIG. 2 is a schematic view illustrating a partial cross-section of another embodiment of the electrophotographic image forming apparatus of the present invention;

FIG. 3 is a schematic view illustrating a cross-section of an embodiment of the process cartridge of the present invention;

FIG. 4 is a schematic view illustrating a partial cross-section of a third embodiment of the electrophotographic image forming apparatus of the present invention;

FIG. 5 is a schematic view illustrating a partial cross-section of a fourth embodiment of the electrophotographic image forming apparatus of the present invention;

FIG. 6 is a schematic view illustrating a partial cross-section of a fifth embodiment of the electrophotographic image forming apparatus of the present invention;

FIG. 7 is across-sectional view of an embodiment of layers of the electrophotographic photoreceptor of the present invention;

FIG. 8 is a cross-sectional view of another embodiment of layers of the electrophotographic photoreceptor of the present invention;

FIG. 9 is a cross-sectional view of a third embodiment of layers of the electrophotographic photoreceptor of the present invention;

FIG. 10 is a cross-sectional view of a fourth embodiment of layers of the electrophotographic photoreceptor of the present invention;

FIG. 11 is a cross-sectional view of a fifth embodiment of layers of the electrophotographic photoreceptor of the present invention;

FIG. 12 is a cross-sectional view of a sixth embodiment of layers of the electrophotographic photoreceptor of the present invention;

FIG. 13 is a cross-sectional view of a seventh embodiment of layers of the electrophotographic photoreceptor of the present invention;

FIG. 14 is a cross-sectional view of an eighth embodiment of layers of the electrophotographic photoreceptor of the present invention;

FIG. 15 is a diagram representing a charge transport dependency of a charge transport layer on an electric filed strength;

FIG. 16 is a diagram representing a change of irradiated part potential for a time from irradiation to development; and

FIG. 17 is a diagram representing a relationship between a fluorochemical surfactant and a surface free energy in a mixture of binder resins.

### DETAILED DESCRIPTION OF THE INVENTION

Generally, the present invention provides an electrophotographic photoreceptor having both high abrasion resistance and a low surface friction, which are persistent even after repeatedly used for long periods.

In the present invention, it is essential that an outermost layer of a photoreceptor, i.e., a photoreceptor including a protective layer includes a predetermined amount of a particulate fluorine-containing resin and a fluorochemical surfactant therein and a photoreceptor not including a protective layer includes those in an outermost layer of its photosensitive layer, and that a surface free energy of the particulate fluorine-containing resin is larger than that of a mixture of the other resins (binder resins) in the protective layer or outermost layer. The fluorine-containing resin is known as a resin having a small surface free energy, and a binder material having a smaller surface free energy than the fluorine-containing resin has to be used.

When this surface free energy relationship is not satisfied, as Comparative Examples mentioned later, the first object of the present invention cannot be attained.

In the present invention, a dosage of the fluorochemical surfactant is an important factor to satisfy the surface free energy relationship, and controlling the dosage thereof can control the surface free energy of the mixture of binder resins.

The dosage of the fluorochemical surfactant differs depending on a sort thereof, and a predetermined or more amount thereof included in a surface layer can control a variation of the surface free energy even when released therefrom. Specifically, the fluorochemical surfactant is preferably included in an amount not less than 5% by weight based on total weight of the mixture of binder resins.

A lubricant is effectively included in an outermost layer of a photoreceptor as means of lowering a surface free energy of a surface of a photoreceptor. The lubricant is preferably a liquid lubricant or a uniformly dispersible solid lubricant having a small particle diameter to secure a smoothness of the surface of a photoreceptor. Specific examples of such lubricants include silicone compounds, particulate fluorine-containing resins, long-chain alkyl compounds, etc. However, the silicone compounds are typically difficult to maintain a low surface friction coefficient of the photoreceptor because of tending to bleed out to the surface thereof from an inside of a surface layer thereof.

A lubricant having less deterioration due to a charging process using a corona discharge is preferably used because electrophotographic processes optionally need the charging process using a corona discharge. The fluorine-containing resin is preferably used as a stable material against a chemical reaction. Specific examples of the fluorine-containing resin include polytetrafluoroethylene, tetrafluoroethylene/perfluoroalkylvinylether copolymers or tetrafluoroethylene/hexafluoropropylene copolymers. These effectively lower the surface free energy and have cost merits because of being comparatively inexpensive.

As disclosed in Japanese Laid-Open Patent Publication No. 5-307265 (paragraph [0006]), a fluorine-containing resin is included in an outermost layer of a photoreceptor, and further the fluorine-containing resin needs to be projected from a surface thereof to lower a surface free energy thereof.

In the present invention, a content of the fluorine-containing resin included in an outermost layer of a photoreceptor is effectively increased to project the fluorine-containing resin from a surface thereof. Specifically, the content of the fluorine-containing resin needs to be not less than 20% by volume based on total volume of a layer including the fluorine-containing resin. A low surface free energy of a photoreceptor is occasionally insufficient according to an apparatus including the photoreceptor. Therefore, the content of the particulate fluorine-containing resin is more preferably not less than 35% by volume, and not greater than 70% by volume to secure a surface smoothness of a photoreceptor.

To maintain a low friction coefficient of a surface of a photoreceptor even after repeatedly used for long periods, a primary particle of the particulate fluorine-containing resin and a secondary particle formed of agglomerated primary particles thereof, which are projected from a surface of an outermost layer of the photoreceptor and have an average particle diameter of from 0.15 to 3 μm are preferably present in an area ratio of from 10 to 60% based on total surface area of the outermost layer.

The average particle diameter of the primary particle or the secondary particle is an average of inner diameters passing through a center of gravity of an image of the particle when measured at intervals of every angle of 20. In the present invention, randomly sampled 10 points of a surface of a photoreceptor were photographed using a SEM (S-4200 from Hitachi, Ltd.) at an acceleration voltage of 2 kv and a magnification of 4,000 times to prepare a SEM image. The SEM image was analyzed using an image processing software (IMAGE Pro Plus) to determine the number of particulate fluorine-containing resins (including primary and agglomerated secondary particles), an average diameter, an area and an area ratio of each particle, and a total area ratio of particles having an average diameter of from 0.15 to 3 μm is determined.

A coverage of a fluorine atom over a surface of a photoreceptor is preferably not less than 30% to maintain a low friction coefficient of a surface thereof even after repeatedly used for long periods. Specifically, the coverage thereof can be determined with mapping data of elements based on a XPS measurement.

Conventionally, Japanese Laid-Open Patent Publications Nos. 6-83097 and 6-208239 disclose a method of specifying a content of a fluorine atom in a surface of a photoreceptor as means of lowering surface free energy thereof. However, the resultant photoreceptor does not have sufficiently a low surface free energy in many cases because ratios of a fluorine atom and a carbon atom based on the XPS measurement on a surface of the photoreceptor are widely specified in both of the publications. In addition, even a photoreceptor satisfying the specifications of the publications cannot maintain a low surface friction coefficient in many cases.

The present inventors discovered that a low surface friction coefficient of a photoreceptor can be more effectively maintained by increasing a coverage of the fluorine atom over a surface of the photoreceptor than increasing a content thereof in a surface of a photoreceptor. In addition, the present inventors discovered that the fluorine-containing resin projected from the surface of the photoreceptor can be expanded thereover in a thin-layer form by frictionizing the fluorine-containing resin. Particularly when the coverage is not less than 30%, the present inventors discovered that the surface friction coefficient of a photoreceptor does not increase even after repeatedly used for long periods. The reason of this is not clarified yet, but it is now considered as follows. Namely, when a surface of a photoreceptor is less covered with a fluorine atom, a part thereof which is not covered therewith deteriorates after repeatedly used for long periods, resulting in rapid increase of a surface friction coefficient. However, when the fluorine atom (fluorine-containing resin) widely covers the surface of the photoreceptor even if the fluorine atom thinly covers the surface thereof, the fluorine atom (fluorine-containing resin) covers a deterioration of the surface thereof in a charging process and an increase of the surface friction coefficient is prevented.

To make the coverage of the fluorine atom over the surface of the photoreceptor not less than 30%, means of mechanically extending (hereinafter referred to as spreading) the fluorine-containing resin projected therefrom due to its ductility is invented. The fluorine-containing resin can also be spread when a photoreceptor is frictionized with a transfer body such as a transfer sheet and a transfer belt. However, the fluorine-containing resin can more properly and uniformly be spread by frictionizing the surface of the photoreceptor with a special blade.

When a frictionizing pressure using these members is too low, the fluorine-containing resin is insufficiently spread. When too high, an unnecessary energy is required to drive the photoreceptor. Specifically, the surface of the photoreceptor is preferably frictionized at a pressure of from 5 to 50 gf/cm. The pressure is determined by dividing a total load (gf) applied to a frictionizing member with a total contact length thereof to the surface of the photoreceptor.

A photoreceptor, over the surface of which a fluorine-containing resin is spread, can maintain a low surface friction coefficient and improve cleanability.

To maintain a good spreading, the photoreceptor preferably has a proper working speed. When the photoreceptor works at a linear speed not less than 100 mm/sec, a proper amount of the fluorine-containing resin covers the surface of the photoreceptor in many cases. When the linear speed is too fast, a mechanical burden thereon becomes large. Therefore, the photoreceptor preferably works at a linear speed of from 100 to 500 mm/sec.

As mentioned before, it is known that when a photoreceptor includes a fluorine-containing resin in its surface layer, the surface layer becomes fragile, resulting in deterioration of an abrasion resistance of the photoreceptor.

The present inventors discovered that, as disclosed in paragraph [0012] of Japanese Laid-Open Patent Publication No. 7-13381, a fluorochemical dispersant supplementarily used to disperse a fluorine-containing resin promotes a low surface free energy of a photoreceptor. At the same time, the present inventors discovered that the fluorochemical dispersant affects a binding between the fluorine-containing resin and a binder resin, and that these parameters affect an abrasion resistance and a low surface free energy of a photoreceptor. The binding is related to a wettability between the fluorine-containing resin and binder resin, and preferably from 40 mN/m to 60 mN/m.

Namely, when the binding between the fluorine-containing resin and binder resin is low, a layer formed thereof deteriorates.

At the same time, when the binder resin has a surface free energy lower than that of the fluorine-containing resin, the fluorine-containing resin has good spreadability. Specifically, the binder resin preferably has a surface free energy not greater than ¾ thereof of the fluorine-containing resin.

Typically, when a content of the fluorochemical surfactant is not less than 5% by weight based on total weight of outermost layer materials except for the particulate fluorine-containing resin (hereinafter referred to as a mixture of binder resins), the binder resin has a surface free energy not greater than ¾ thereof of the fluorine-containing resin.

When the binding between the particulate fluorine-containing resin and mixture of binder resins is too high, the mixture of binder resins easily bind with foreign particles besides the particulate fluorine-containing resin, and therefore filming of a residual toner and a paper dust from a print paper over a surface of a photoreceptor tends to occur.

To avoid such problems, the binding between the particulate fluorine-containing resin and mixture of binder resins is preferably not greater than 60 mN/m.

As the fluorochemical surfactant, a copolymer between methacrylate and fluoroalkyl acrylate is effectively used, and particularly a photoreceptor using a block copolymer therebetween has less time deterioration of images due to repeated use for long periods. In addition, the present inventors discovered that a photoreceptor including the fluorochemical surfactant in its surface layer in a specified amount produces high-quality images without deterioration of image resolution even when exposed to an oxidizing gas.

A reason why the binding between the particulate fluorine-containing resin and mixture of binder resins affects an abrasion resistance of a photoreceptor is not clarified, but it is considered that when the binding is small, an affinity between the particulate fluorine-containing resin and mixture of binder resins in a layer is low and the particulate fluorine-containing resin becomes a void. A load applied to a photoreceptor is considered to concentrate on a local area thereof, which is considered to cause a fragile layer. When the binding is large, the affinity between the particulate fluorine-containing resin and mixture of binder resins increases and the mixture of binder resins prevents the particulate fluorine-containing resin from releasing therefrom. A load applied to a photoreceptor is considered not to concentrate on a local area thereof. Therefore, the abrasion resistance of a photoreceptor is considered to increase.

To further improve the abrasion resistance of a photoreceptor, as disclosed in Japanese Laid-Open Patent Publication No. 2001-125299, a binder resin in a surface layer of a photoreceptor is effectively crosslinked. When the binder resin is crosslinked, it is essential that a solid content of the fluorochemical surfactant is a part of the resultant crosslinked resin. A reason why the abrasion resistance of a photoreceptor is improved when the binder resin is crosslinked is considered that the number of chemical bonding of the binder resin increases and a total sum of chemical bonding energy in a whole layer increases.

The crosslinked resin including a charge transport material mentioned later has a higher sensitivity. In addition, a melamine resin is advantageously used as a crosslinker with the solid content of the fluorochemical surfactant to improve the abrasion resistance and sensitivity of a photoreceptor.

Next, essential electrostatic properties of a photoreceptor will be explained.

As disclosed in paragraph [0014] of Japanese Laid-Open Patent Publication No. 6-95415, when the particulate fluorine-containing resin is included in a photosensitive layer in an amount greater than 50% by weight, transportability a photo induced charge carrier decreases and sensitivity of a photoreceptor deteriorates. A space charge is formed in the photosensitive layer including the particulate fluorine-containing resin because of an accumulation of residual potential in accordance with Poisson equation and a stagnation of late charge carrier. When an accumulation of the space charge in the photosensitive layer is trapped in an interface between layers, the number of the space charge is proportional to the first power of the layer thickness. When the space charge accumulates in a bulk of the layer, the number of the space charge is proportional to the square of the layer thickness. Consequently, the resultant photoreceptor produces images having a low image density or defective images such as negative or positive residual image. Particularly, a photosensitive layer including a large amount of the particulate fluorine-containing resin has more of this tendency.

To solve this problem, the particulate fluorine-containing resin is more localized at a surface of the photoreceptor than being uniformly dispersed in a photosensitive or a charge transport layer. When the photosensitive layer includes a large amount of the particulate fluorine-containing resin, a local layer thickness thereof is advantageously thin in terms of sensitivity.

The local layer thickness of the particulate fluorine-containing resin is preferably from 1 to 15 μm, and more preferably from 2 to 5 μm although differing according to a formulation of the photosensitive layer. The local layer thickness of the particulate fluorine-containing resin is at least not less than 1 μm, and preferably not less than 2 μm such that a photoreceptor maintains a low surface friction coefficient against repeated use for long periods.

A photoreceptor having such a structure can be formed by coating a protective layer including a large amount of the fluorine-containing resin, a photosensitive layer including a large amount thereof or a charge transport layer including a large amount thereof on a surface of a conventional single-layered photoreceptor having a photosensitive layer as an outermost layer or a multilayered photoreceptor having a charge transport layer as an outermost layer.

First, the electrophotographic image forming apparatus of the present invention will be explained, referring to the drawings.

Desktop or floor-type image forming apparatuses using an indirect electrophotographic method (Xerograph method) such as facsimiles, laser printers, electrophotographic copiers, direct platemakers and their complex machines widely used as image forming apparatuses are typically equipped with an electrophotographic photoreceptor (or an image bearer), a charger, an imagewise light irradiator, an image developer, a transferer, a separator, a cleaner, a discharger, a fixer, a copy paper (a receiving material) feed tray and a catch tray.

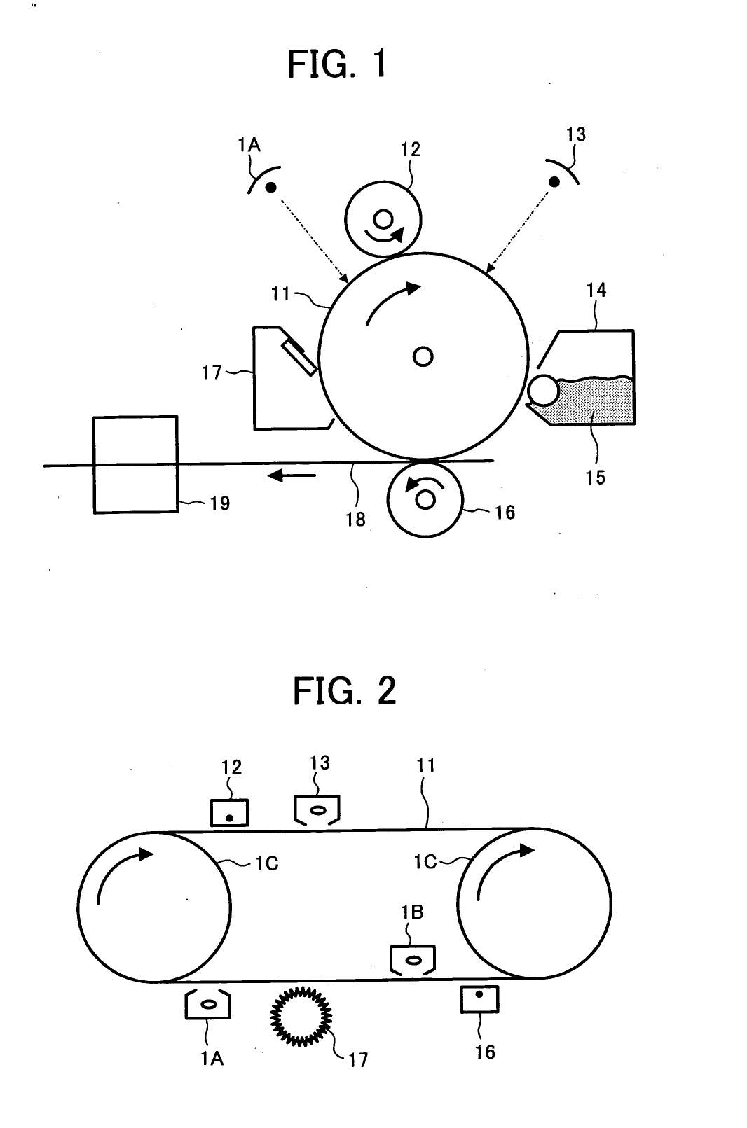

FIG. 1 is a schematic view illustrating a partial cross-section of an embodiment of the electrophotographic image forming apparatus of the present invention, and a modified embodiment as mentioned later belongs to a scope of the present invention.

In FIG. 1, a photoreceptor 11 includes at least a charge generation material, a charge transport material, a particulate fluorine-containing resin and a fluorochemical surfactant, wherein the particulate fluorine-containing resin and fluorochemical surfactant are included in an outermost layer of the photoreceptor 11; the particulate fluorine-containing resin is included therein in an amount of from 20 to 70% by volume based on total volume thereof; and a solid content of the fluorochemical surfactant is included therein in an amount of from 5 to 70% by weight based on total weight of a mixture of binder resins included therein. The photoreceptor 11 has the shape of a drum, and may have the shape of an endless belt.

The photoreceptor 11 is charged by a charger 12.

A corona charger, a contact charger and a close (or non-contact) charger can be used as the charger 12.

The corona charger includes a discharge wire (such as a tungsten wire) having a diameter of 40 to 60 μm set up in a U-shaped sealed case. A DC voltage of from −4,000 to −7000 V is applied to the corona charger to discharge silently to charge the photoreceptor apart therefrom for 8 to 10 mm.

The corona charger is usually equipped with a grid to uniformly charge the photoreceptor when negatively charged.

Specific examples of the contact and close chargers include brush-shaped chargers formed of resistance-controlled fibers wherein a low-resistance material such as a carbon is dispersed in carbon and chemical fibers; a single unit of epichlorohydrin rubber; a roller-shaped charger including carbon to control resistance, and an optionally a fluorocarbon resin and silica; and another roller-shaped charger wherein carbon, a metallic powder and an ionic electroconductive material are dispersed in a resin to control resistance. The charging members are installed in a unit to contact the photoreceptor 11 or to be located apart therefrom for 30 to 80 μm. A DC voltage of from −400 to −1,000 V or a voltage wherein a DC voltage overlapped with an AC voltage of from 800 to 2,500 V/from 800 to 4500 Hz is applied to the charging members.

The photoreceptor has a charge potential of from −400 to −800 V.

The corona charger has a good charge lockability, but generates a large amount of ozone (about 10 ppm) causing an environmental problem. On the other hand, since the contact charger and close (or non-contact) charger contacts or is located close to the photoreceptor, the charging member is contaminated and the photoreceptor tends to be nonuniformly charged. However, the contact charger and close (or non-contact) charger are widely used because they are compact, consume less electricity to save energy and generate less ozone (0.05 to 0.3 ppm).

After the photoreceptor 11 is uniformly charged, a signal from an original image and a personal computer is irradiated by an irradiator 13 formed of a CCD, a LD or a LED element, a polygon mirror, a filter, a cylindrical lens, etc. as a dot pattern on the photoreceptor 11 to form a digital-pattern electrostatic latent image (a difference between a light potential and a dark potential).

The electrostatic latent image is developed by an image developer 14 using a magnet brush developing method.

The image developer 14 includes a developer including a magnetic powder having an average particle diameter of from 40 to 80 μm and a toner having a particle diameter of from 4 to 10 μm, wherein the toner has a concentration of from 3 to 8% by weight. A developing bias is applied to the image developer.

The toner for use in the developer includes a irregularly-and-odd shaped pulverized toner mechanically prepared and a polymerized toner chemically prepared (by a suspension polymerization method or an emulsification polymerization method). Recently, in accordance with requirements for higher-quality images, a polymerized toner is more used because of its lower production cost, uniform shape and uniform potential.

A toner image formed by the development is transferred by a transferer 5, to which a reversal polar voltage to that of the toner is applied, onto an image-receiving medium (copy paper) 18 transported from a paper feed tray 1H, and is transported to a fixer 19 to be fixed thereon. The image-receiving medium on which the toner image is fixed is discharged onto a catch tray 1K as a hardcopy 1J.

After a residual toner on the photoreceptor after transfer is removed by a cleaner 17 including a cleaning blade formed of a rubber-like elastic body, the photoreceptor surface is wholly irradiated by a discharger 1A to discharge an inner latent image, and the photoreceptor is electrically initialized. Thus, a copy cycle is finished.

The electrophotographic image forming apparatus of the present invention preferably has a spreader spreading the fluorine-containing resin projected from a surface of the photoreceptor. The spreader can be substituted with a contact member to the photoreceptor such as a cleaning blade. However, an exclusive spreader is more preferably used than using the cleaning blade both for cleaning and spreading. The spreader may have any shapes, provided the spreader can apply a load on the surface of the photoreceptor, however, the spreader preferably has the shape of a blade, a brush or a roll uniformly applying a load thereon. In addition, the load applied on the photoreceptor is preferably from 5 to 50 gf/cm.

When a photoreceptor positively or negatively charged is exposed to imagewise light, an electrostatic latent image having a positive or negative charge is formed thereon. When the latent image having a positive charge is developed with a toner having a negative charge, a positive image can be obtained. In contrast, when the latent image having a positive charge is developed with a toner having a positive charge, a negative image (i.e., a reversal image) can be obtained.

As the developing method, known developing methods can be used. In addition, as the discharging methods, known discharging methods can also be used.

FIG. 2 is a schematic view illustrating a partial cross-section of another embodiment of the electrophotographic image forming apparatus of the present invention.

In FIG. 2, a photoreceptor 11 includes at least a charge generation material, a charge transport material, a particulate fluorine-containing resin and a fluorochemical surfactant, wherein the particulate fluorine-containing resin and fluorochemical surfactant are included in an outermost layer of the photoreceptor 11; the particulate fluorine-containing resin is included therein in an amount of from 20 to 70% by volume based on total volume thereof; and a solid content of the fluorochemical surfactant is included therein in an amount of from 5 to 70% by weight based on total weight of a mixture of binder resins included therein.

The photoreceptor 11 has the shape of a belt, and may have the shape of a drum, a sheet or an endless belt. The photoreceptor 11 is driven by a driver 1C. Charging using a charger 12, imagewise light exposure using an irradiator 13, developing (not shown), transferring using a transferer 16, pre-cleaning irradiating using a pre-cleaning irradiator 1B, cleaning using a cleaner 17 and discharging using a discharger 1A are repeatedly performed. In FIG. 2, the pre-cleaning irradiating is performed from a side of a substrate of the photoreceptor. In this case, the substrate has to be light-transmissive.

This electrophotographic image forming apparatus of the present invention preferably has a spreader spreading the fluorine-containing resin projected from a surface of the photoreceptor as well. As mentioned above, the spreader can be substituted with a contact member to the photoreceptor such as a cleaning blade. However, an exclusive spreader is more preferably used than using the cleaning blade both for cleaning and spreading. The spreader may have any shapes, provided the spreader can apply a load on the surface of the photoreceptor, however, the spreader preferably has the shape of a blade, a brush or a roll uniformly applying a load thereon.

The electrophotographic image forming apparatuses of the present invention are not limited to those shown in FIGS. 1 and 2. For example, although the pre-cleaning irradiating is performed from the substrate side in FIG. 2, the pre-cleaning light irradiating can be performed from a photosensitive layer side of the photoreceptor. In addition, irradiating in the imagewise light irradiation process and the discharge process may be performed from the substrate side of the photoreceptor.

On the other hand, imagewise light irradiation, pre-cleaning irradiation and discharge irradiation are shown in FIGS 2, and other known irradiations such as pre-transfer irradiation, pre-imagewise-light-irradiation irradiation can be performed.

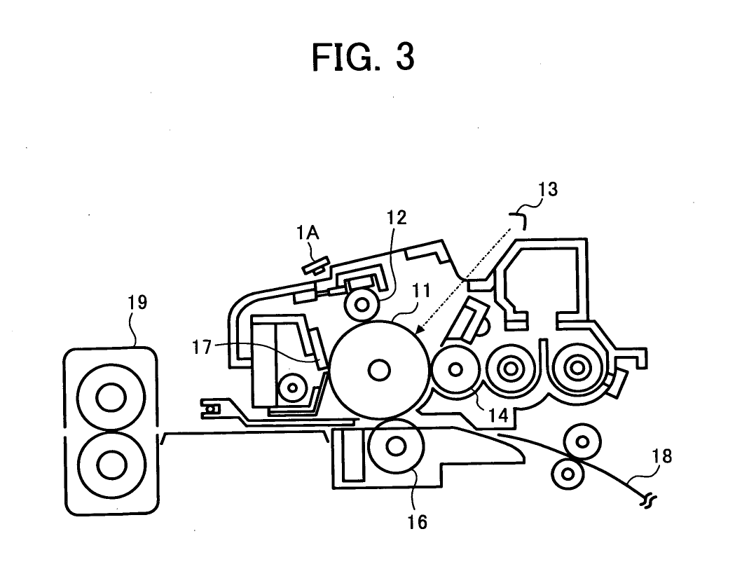

The above-mentioned electrophotographic image forming apparatuses may fixedly be set in a copier, a facsimile or a printer, and may be set therein as a process cartridge. The process cartridge in the present invention includes a photoreceptor, a spreader and at least a member selected from the group consisting of chargers, irradiators, image developers, transferers, cleaners and dischargers. The process cartridge has many shapes, and an embodiment thereof is shown in FIG. 3. The photoreceptor 11 has the shape of a drum, and may have the shape of a sheet or an endless belt.

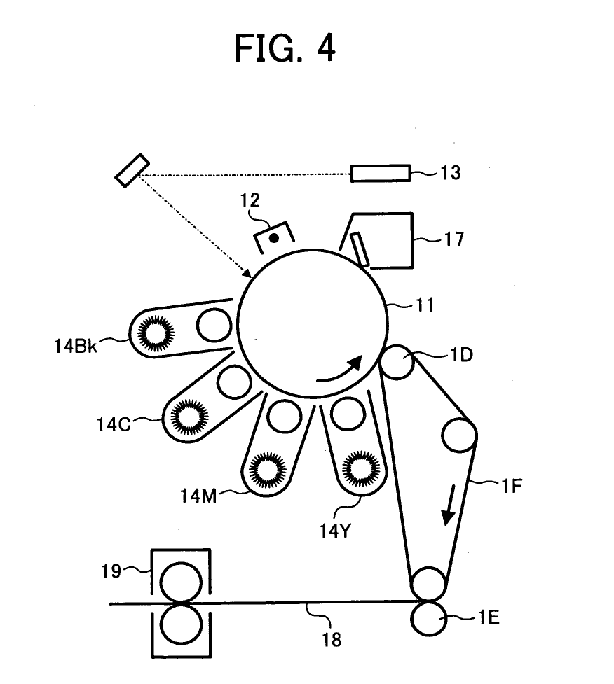

FIG. 4 is a schematic view illustrating a partial cross-section of a third embodiment of the electrophotographic image forming apparatus of the present invention. The electrophotographic image forming apparatus include a photoreceptor 11; and a charger 12, in irradiator 13, image developers 14Bk, 14C, 14M and 14Y for each color toner of black (Bk), cyan (C), magenta (M) and yellow (Y), an intermediate transfer belt 1F as an intermediate transferer and a cleaner 17 around the photoreceptor. The photoreceptor 11 includes at least a charge generation material, a charge transport material, a particulate fluorine-containing resin and a fluorochemical surfactant, wherein the particulate fluorine-containing resin and fluorochemical surfactant are included in an outermost layer of the photoreceptor 11; the particulate fluorine-containing resin is included therein in an amount of from 20 to 70% by volume based on total volume thereof; and a solid content of the fluorochemical surfactant is included therein in an amount of from 5 to 70% by weight based on total weight of a mixture of binder resins included therein.

The image developers 14Bk, 14C, 14M and 14Y can independently be controlled, and only the image developer forming a color is driven. A toner image formed on the photoreceptor 11 is transferred onto an intermediate transfer belt 1F by a first transferer 1D located inside the intermediate transfer belt 1F. The first transferer 1D is located so as to be capable of contacting and releasing from the photoreceptor 11, and contacts the intermediate transfer belt 1F to the photoreceptor 11 only when transferring a toner image. After each color toner image layered on the intermediate transfer belt 1F is transferred onto an image receiving media 18 at a time by a second transferer 1E, the toner image is fixed thereon by a fixer 19. The second transferer 1E is also located so as to be capable of contacting and releasing from the photoreceptor 11, and contacts the intermediate transfer belt 1F to the photoreceptor 11 only when transferring a toner image.

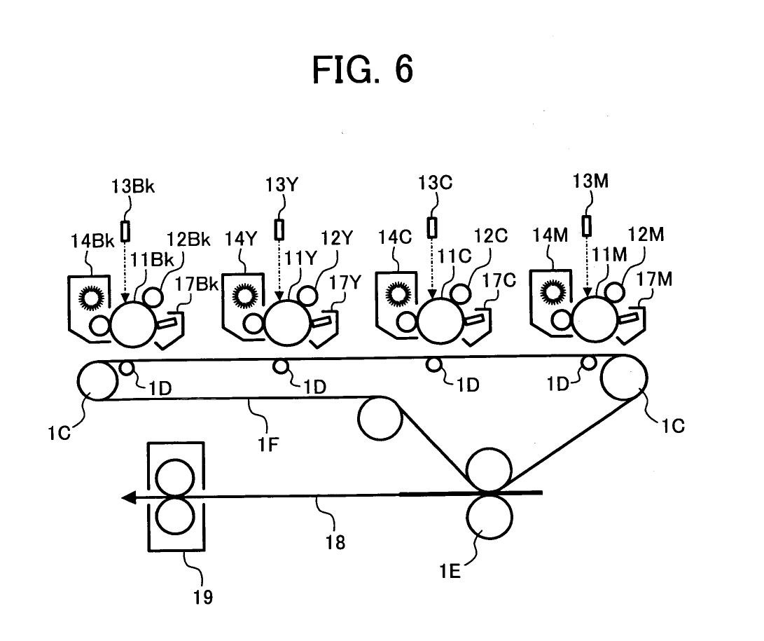

While an electrophotographic image forming apparatus using a transfer drum cannot print on a thick paper because a transfer material electrostatically sticks to the transfer drum, the electrophotographic image forming apparatus using an intermediate transferer in FIG. 4 does not have a limit of the transfer material because each color toner image is layered on the intermediate transfer belt 1F. Such an intermediate transferer can be applied not only to the apparatus in FIG. 4 but also to the apparatuses in FIGS. 1 to 3 and 5 to 6 mentioned later. This electrophotographic image forming apparatus of the present invention preferably has a spreader spreading the fluorine-containing resin projected from a surface of the photoreceptor as well. As mentioned above, the spreader can be substituted with a contact member to the photoreceptor such as a cleaning blade. However, an exclusive spreader is more preferably used than using the cleaning blade both for cleaning and spreading. The spreader may have any shapes, provided the spreader can apply a load on the surface of the photoreceptor, however, the spreader preferably has the shape of a blade, a brush or a roll uniformly applying a load thereon.

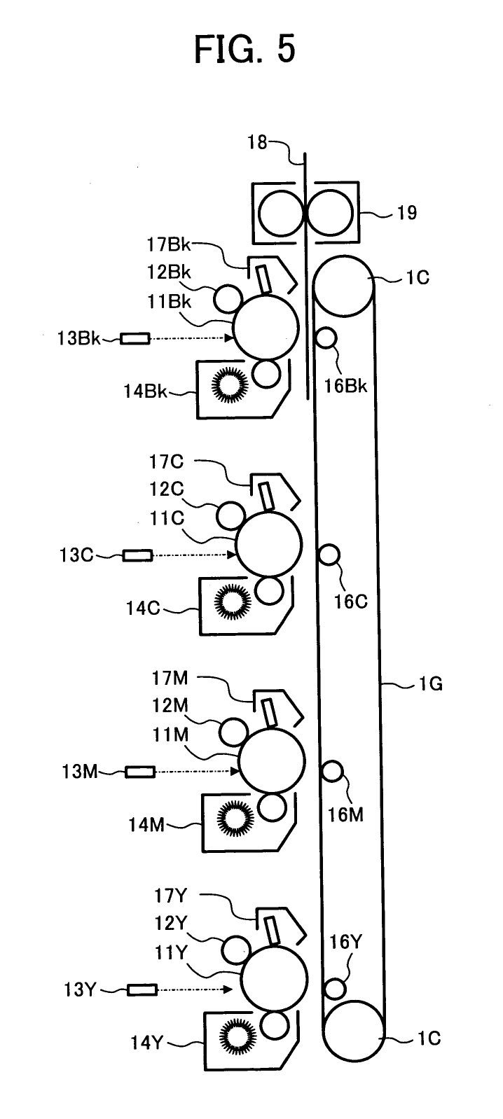

FIG. 5 is a schematic view illustrating a partial cross-section of a fourth embodiment of the electrophotographic image forming apparatus of the present invention. This electrophotographic image forming apparatus uses four color toners, i.e., a yellow (Y) toner, a magenta (M) toner, cyan (C) toner and black (Bk) toner, and has image forming units and photoreceptors 11Y, 11M, 11C and 11Bk for each color. The photoreceptor 11 includes at least a charge generation material, a charge transport material, a particulate fluorine-containing resin and a fluorochemical surfactant, wherein the particulate fluorine-containing resin and fluorochemical surfactant are included in an outermost layer of the photoreceptor 11; the particulate fluorine-containing resin is included therein in an amount of from 20 to 70% by volume based on total volume thereof; and a solid content of the fluorochemical surfactant is included therein in an amount of from 5 to 70% by weight based on total weight of a mixture of binder resins included therein.

Around each of the photoreceptors 11Y, 11M, 11C and 11Bk, a charger 12, an irradiator 13, an image developer 14 and a cleaner 17, etc. are located. A transport transfer belt 1G as a transfer material bearer contacting and leaving from each transfer position of each photoreceptor 11Y, 11M, 11C and 11Bk is hung over a driver 1C. A transferer 16 is located at a transfer position opposite to each of the photoreceptors 11Y, 11M, 11C and 11Bk across the transport transfer belt 1G.

This electrophotographic image forming apparatus of the present invention preferably has a spreader spreading the fluorine-containing resin projected from a surface of the photoreceptor as well. As mentioned above, the spreader can be substituted with a contact member to the photoreceptor such as a cleaning blade. However, an exclusive spreader is more preferably used than using the cleaning blade both for cleaning and spreading. The spreader may have any shapes, provided the spreader can apply a load on the surface of the photoreceptor, however, the spreader preferably has the shape of a blade, a brush or a roll uniformly applying a load thereon.

The electrophotographic image forming apparatus as shown in FIG. 5 has photoreceptors 11Y, 11M, 11C and 11Bk for each color and sequentially transfer each color toner image onto an image receiving media 18 borne by the transport transfer belt 1G, and therefore can produce full-color images at a far higher-speed than that of a full-color image forming apparatus having only one photoreceptor.

Hereinafter, the organic electrophotographic photoreceptor of the present invention will be explained in detail, referring to the drawings.

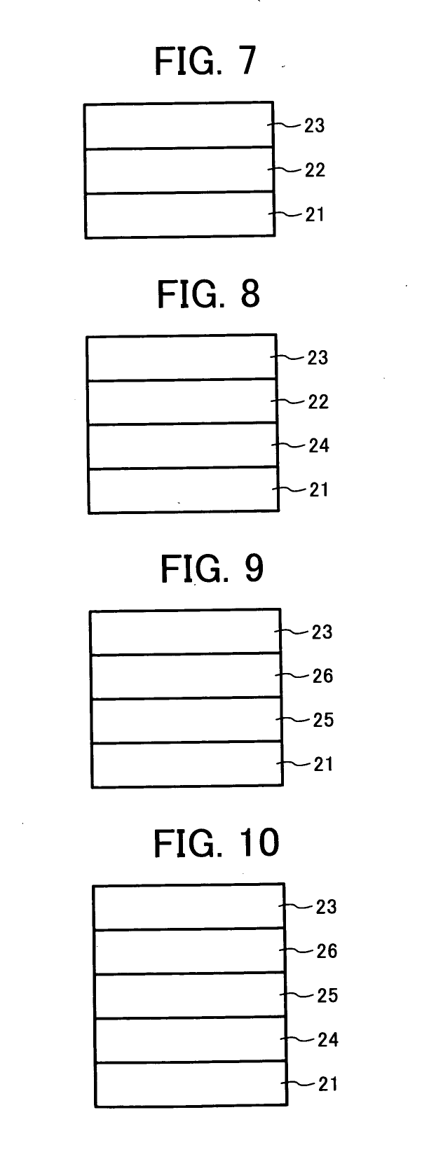

FIG. 7 is a cross-sectional view of an embodiment of layers of the electrophotographic photoreceptor of the present invention, wherein a mixed-type photosensitive layer not including a fluorine-containing resin 22 and a protective layer 23 are formed on an electroconductive substrate 21.

FIG. 8 is a cross-sectional view of another embodiment of layers of the electrophotographic photoreceptor of the present invention, wherein in addition to the layer constitution in FIG. 7, an undercoat layer 24 is formed between an electroconductive substrate 21 and a mixed-type photosensitive layer not including a fluorine-containing resin 22.

FIG. 9 is a cross-sectional view of a third embodiment of layers of the electrophotographic photoreceptor of the present invention, wherein a charge generation layer 25, a charge transport layer not including a fluorine-containing resin 26 and a protective layer 23 are formed on an electroconductive substrate 21.

FIG. 10 is a cross-sectional view of a fourth embodiment of layers of the electrophotographic photoreceptor of the present invention, wherein in addition to the layer constitution in FIG. 9, an undercoat layer 24 is formed between an electroconductive substrate 21 and a charge generation layer 25.

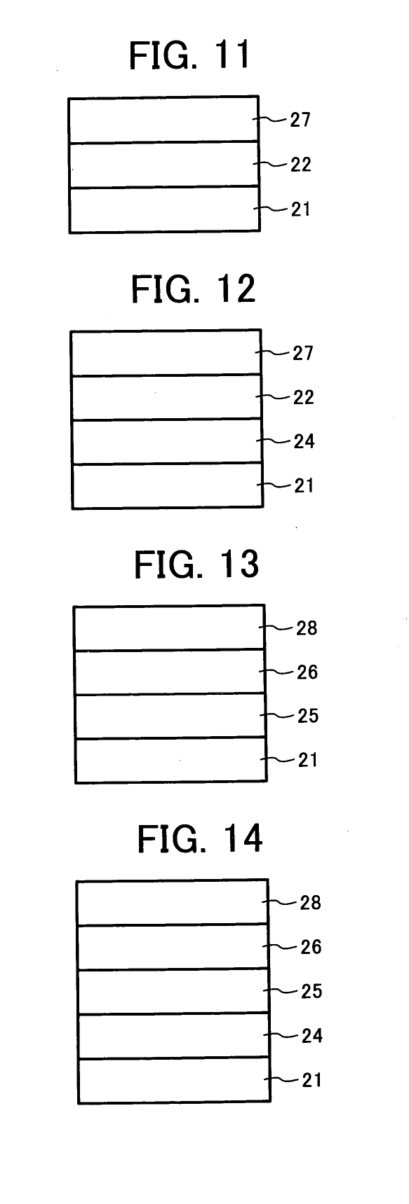

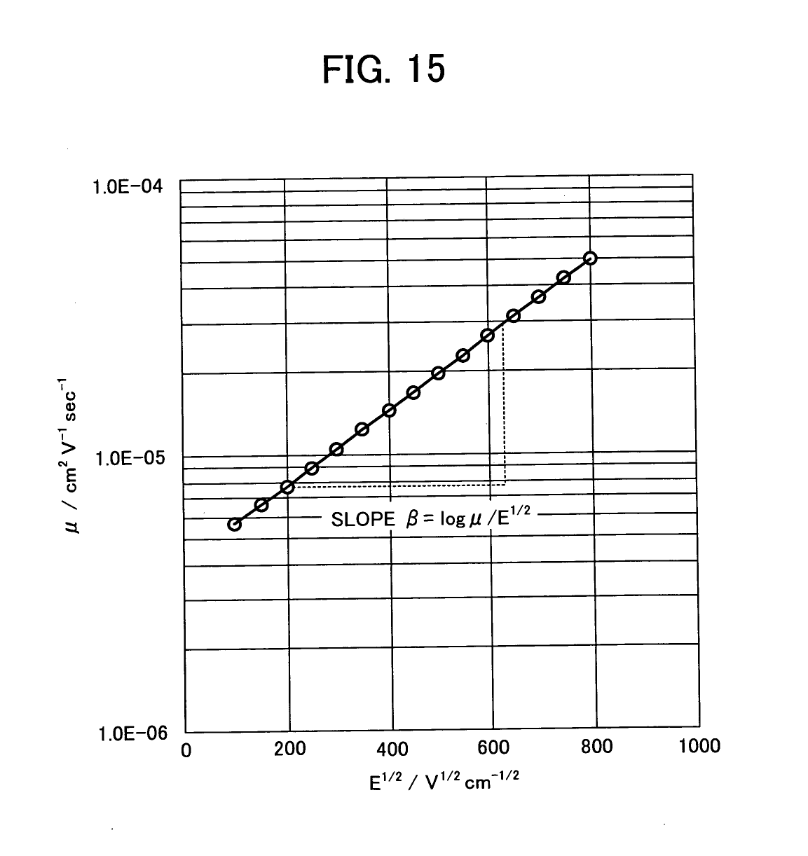

FIG. 11 is a cross-sectional view of a fifth embodiment of layers of the electrophotographic photoreceptor of the present invention, wherein a mixed-type photosensitive layer not including a fluorine-containing resin 22 and a mixed-type photosensitive layer including a fluorine-containing resin 27 are formed on an electroconductive substrate 21.

FIG. 12 is a cross-sectional view of a sixth embodiment of layers of the electrophotographic photoreceptor of the present invention, wherein in addition to the layer constitution in FIG. 11, an undercoat layer 24 is formed between a mixed-type photosensitive layer not including a fluorine-containing resin 22 and an electroconductive substrate 21.

FIG. 13 is a cross-sectional view of a seventh embodiment of layers of the electrophotographic photoreceptor of the present invention, wherein a charge generation layer 25, a charge transport layer not including a fluorine-containing resin 26 and a charge transport layer including a fluorine-containing resin 28 are formed on an electroconductive substrate 21.

FIG. 14 is a cross-sectional view of an eighth embodiment of layers of the electrophotographic photoreceptor of the present invention, wherein in addition to the layer constitution in FIG. 13, an undercoat layer 24 is formed between a charge generation layer 25 and an electroconductive substrate 21.

Suitable materials as the electroconductive substrate 21 include materials having a volume resistance not greater than 10¹⁰ Ω·cm. Specific examples of such materials include plastic cylinders, plastic films or paper sheets, on the surface of which a metal such as aluminum, nickel, chromium, nichrome, copper, gold, silver, platinum and the like, or a metal oxide such as tinoxides, indium oxides and the like, is deposited or sputtered. In addition, a plate of a metal such as aluminum, aluminum alloys, nickel and stainless steel and a metal cylinder, which is prepared by tubing a metal such as the metals mentioned above by a method such as drawing ironing, impact ironing, extruded ironing and extruded drawing, and then treating the surface of the tube by cutting, super finishing, polishing and the like treatments, can also be used as the substrate.

The photosensitive layer in the present invention may be a mixed-type photosensitive layer or a multilayered photosensitive layer including a charge generation layer and a charge transport layer sequentially layered.

The mixed-type photosensitive layer in the present invention is a photosensitive layer wherein a charge generation material and a charge transport material are dispersed together. The multilayered photosensitive layer is a photosensitive layer wherein a charge generation layer including a charge generation material and a charge transport layer including a charge transport material are sequentially layered. In the present invention, these are referred to as a mixed-type photoreceptor and a multilayered photoreceptor respectively.

First, the multilayered photoreceptor will be explained.

A charge generation layer in the multilayered photoreceptor will be explained, first. The charge generation layer is a part of the multilayered photosensitive layer and generates a charge when irradiated. Among compounds included in this layer, a charge generation material is a main component thereof. A binder resin is optionally used in the charge generation layer. Inorganic materials and organic materials can be used as the charge generation material.

Specific examples of the inorganic materials include crystalline selenium, amorphous selenium, selenium-tellurium alloys, selenium-tellurium-halogen alloys, selenium-arsenic alloys and amorphous silicone. The amorphous silicone prepared by terminating a dangling bond with a hydrogen atom or a halogen atom, or doping a boron atom or a phosphorus atom. Specific examples of the organic charge generation materials include known materials, for example, phthalocyanine pigments such as metal phthalocyanine and metal-free phthalocyanine, azulenium pigments, squaric acid methine pigments, symmetric or asymmetric azo pigments having a carbazole skeleton, symmetric or asymmetric azo pigments having a triphenylamine skeleton, and the like materials. Among these materials, the metal phthalocyanine, symmetric or asymmetric azo pigments having a fluorenone skeleton, symmetric or asymmetric azo pigments having a triphenylamine skeleton and perylene pigments are preferably used because they all have high charge generation quantum efficiency. These charge generation materials can be used alone or in combination.

Specific examples of the binder resin optionally used in the charge generation layer include polyamide resins, polyurethane resins, epoxy resins, polyketone resins, polycarbonate resins, silicone resins, acrylic resins, polyvinyl butyral resins, polyvinyl formal resins, polyvinyl ketone resins, polystyrene resins, poly-N-vinylcarbazole resins, polyacrylamide resins, and the like resins. These resins can be used alone or in combination.

In addition, a charge transport polymer material can be used as the binder resin in the charge generation layer, and further a low-molecular-weight charge transport material may optionally be included therein.

Charge transport materials which can optionally be used in the charge generation layer include electron transport materials and positive hole transport materials, which are further classified to charge transport polymer materials and low-molecular-weight charge transport materials.

Specific examples of the electron transport materials include electron accepting materials such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitro-xanthone, 2,4,8-trinitrothioxanthone, 2,6,8-trinitro-4H-indeno[1,2-b]thiophene-4-one, 1,3,7-trinitrobenzothiophene-5,5-dioxide, and the like compounds. These electron transport materials can be used alone or in combination.

Specific examples of the positive hole transport materials include electron donating materials such as oxazole derivatives, oxadiazole derivatives, imidazole derivatives, triphenylamine derivatives, 9-(p-diethylaminostyrylanthracene), 1,1-bis(4-dibenzylaminophenyl)propane, styrylanthracene, styrylpyrazoline, phenylhydrazone compounds, α-phenylstilbene derivatives, thiazole derivatives, triazole derivatives, phenazine derivatives, acridine derivatives, benzofuran derivatives, benzimidazole derivatives, thiophene derivatives, and the like materials.

These positive hole transport materials can be used alone or in combination.

Next, the charge transport polymer materials for use in the present invention will be explained. Specific examples of the charge transport polymer materials include the following typical polymer compounds.

Polymers having a carbazole ring such as poly-N-vinylcarbazole, polymers having a hydrazone structure disclosed in Japanese Laid-Open Patent Publication No. 57-78402, polysilylene compounds disclosed in Japanese Laid-Open Patent Publication No. 63-285552, and aromatic polycarbonates disclosed in Japanese Laid-Open Patent Publications Nos. 8-269183, 9-151248, 9-71642, 9-104746, 9-328539, 9-272735, 9-241369, 11-29634, 11-5836, 11-71453, 9-221544, 9-227669, 9-157378, 9-302084, 9-302085, 9-268226, 9-235367, 9-87376, 9-110976 and 2000-38442.

The above-mentioned charge transport polymer materials can be used alone or in combination.

Suitable methods for forming the charge generation layer are broadly classified into thin film forming methods in a vacuum and casting methods.

Specific examples of the former thin film forming methods in a vacuum include vacuum evaporation methods, glow discharge decomposition methods, ion plating methods, sputtering methods, reaction sputtering methods, CVD (chemical vapor deposition) methods, and the like methods. A layer of the above-mentioned inorganic and organic materials can be formed by one of these methods.

The casting methods for forming the charge generation layer typically include the following steps:

(1) preparing a coating liquid by mixing one or more inorganic or organic charge generation materials mentioned above with a solvent such as tetrahydrofuran, cyclohexanone, dioxane, dichloroethane, butanone and the like, optionally together with a binder resin and an additive, and then dispersing the materials with a ball mill, an attritor, a sand mill or the like, to prepare a CGL coating liquid;

(2) coating the CGL coating liquid, which is diluted if necessary, on a substrate by a method such as dip coating, spray coating, bead coating and ring coating; and

(3) drying the coated liquid to form a CGL.

The thickness of the CGL is preferably from about 0.01 to about 5 μm, and more preferably from about 0.05 to about 2 μm.

Next, a charge transport layer not including a fluorine-containing resin will be explained.

The charge transport layer not including a fluorine-containing resin is a part of the multilayered photosensitive layer, which receives a charge generated in the CGL, and transports the charge to a surface of a photoreceptor to neutralize a charge thereof. A main component of the charge transport layer not including a fluorine-containing resin is a charge transport material and a binder resin binding this.

The charge transport layer not including a fluorine-containing resin is a CTL including less fluorine-containing resin than the charge transport layer including a fluorine-containing resin (% by weight based on total weight thereof) or including a fluorine-containing resin in an amount less than 5% by weight based on total weight of the CTL.

The charge transport layer not including a fluorine-containing resin can be formed by dissolving or dispersing a mixture or a copolymer mainly formed of a charge transport material and a binder resin in a solvent to prepare a coating liquid; and coating and drying the coating liquid. Suitable coating methods include a dip coating method, a spray coating method, a ring coating method, a roll coating method, a gravure coating method, a nozzle coating method and a screen printing method.

The charge transport layer not including a fluorine-containing resin preferably has a thickness of from 15 to 40 μm, and more preferably from 15 to 30 μm to have practically required sensitivity and chargeability. Further, preferably from 15 to 25 μm when image resolution is required. A ratio (N/P) of a thickness (N) of the protective layer or charge transport layer including a fluorine-containing resin to a thickness (P) of the charge transport layer not including a fluorine-containing resin is preferably from 0.0125 to 0.67 for the same reasons.

Since the charge transport layer including a fluorine-containing resin or protective layer is formed on the charge transport layer not including a fluorine-containing resin, the charge transport layer not including a fluorine-containing does not have to be designed in consideration of abrasion in practical use, and can be thin.

Suitable solvents for use in the CTL coating liquid include ketone such as methyl ethyl ketone, acetone, methyl isobutyl ketone, and cyclohexanone; ethers such as dioxane, tetrahydrofuran, and ethyl cellosolve; aromatic solvents such as toluene, and xylene; halogen-containing solvents such as chlorobenzene, and dichloromethane; esters such as ethyl acetate and butyl acetate; etc. Particularly, methyl ethyl ketone, tetrahydrofuran and cyclohexanone are more preferably used than chlorobenzene, dichloromethane, toluene and xylene because of their low environmental burdens. These solvents can be used alone or in combination.

Specific examples of the polymers for use as the binder resin of the CTL include thermoplastic resins and thermosetting resins such as, particularly, polystyrene, polyester, polyarylate and polycarbonate are preferably used as a binder of a charge transport material because of their good charge transportability. Since the charge transport layer including a fluorine-containing resin or protective layer is formed on the charge transport layer not including a fluorine-containing resin, the charge transport layer not including a fluorine-containing resin is not required to have a mechanical strength as a conventional CTL. Therefore, a material having high transparency but low mechanical strength such as polystyrene, which used be difficult to use, can effectively be used as a binder for the charge transport layer not including a fluorine-containing resin.

These polymer materials can be used alone or in combination. In addition, copolymers of the monomers of the polymer materials mentioned above can also be used. Further, copolymers of the monomers with a charge transport material can also be used.

However, when one or more layer such as the charge transport layer including a fluorine-containing resin or protective layer are formed on the CTL, the CTL preferably includes a resin soluble in the solvent of the protective layer coating liquid to be coated thereon, such as polystyrene, polyarylate, polycarbonate and phenolic resins, to make an interface between the CTL and one or more layer unclear.

When the interface is unclear, peeling of the one or more layer due to repeated use for long periods can be prevented, and an electric interface barrier can be reduced. Further, when the one or more layer is a protective layer, spreading of a charge transport material included in the CTL thereinto is promoted, resulting in prevention of residual potential.

When an electrically inactive polymer is used to reform a CTL, caldo polymer-type polyester; polyester such as polyethylenephthalate and polyethylenenaphthalate; polycarbonate formed of bisphenol-type polycarbonate, the phenol 3,3′ portion of which is substituted by an alkyl group such as C-type polycarbonate; polycarbonate formed of bisphenol A, the geminal methyl group of which is substituted by a long-chain alkyl group having two or more carbon atoms; polycarbonate having a biphenyl or biphenyl ether skeleton; polycaprolactone; polycarbonate having a long-chain alkyl skeleton such as polycaprolactone disclosed in Japanese Laid-Open Patent Publication No. 7-292095; an acrylic resin; polystyrene and hydrogenated butadiene are effectively used.

Electrically inactive charge transport polymer materials mean polymers which do not have a structure having a photoconductive property, such as the triarylamine structure.

When these resins are used as an additive together with a binder resin, the content thereof is preferably not greater than 50% by weight in view of photosensitivity of the resultant photoreceptor.

Specific examples of the charge transport materials for use in the CTL include the above-mentioned low molecular weight electron transport materials, low molecular weight positive hole transport materials, and charge transport polymer materials.

When a low molecular weight charge transport material is used, a content thereof is preferably from 40 to 200 phr (parts per hundred of resin), and preferably from 70 to 100 phr. When a charge transport polymer is used, a content thereof is preferably from 0 to 200 parts by weight, and preferably from 80 to 150 parts by weight, per 100 parts by weight of the charge transport components included therein.

When two or more kinds of charge transport materials are included in the CTL, the difference in ionization potential between the two or more kinds of charge transport materials is as small as possible, specifically the difference is preferably not greater than 0.15 eV. In this case, it is prevented that one of the charge transport materials serves as a trap of the other charge transport materials.

The ionization potential in the present invention is measured by an atmospheric ultraviolet photoelectron analyzer AC-1 from Riken Keiki Co., Ltd. in a typical method.

Forming a protective layer is disadvantageous to the photosensitivity of the photoreceptor. In order to avoid deterioration of photosensitivity, it is preferable to enhance the charge mobility in the CTL, particularly at a low electric field. Specifically, the charge mobility of the protective layer is preferably not less than 1.2×10⁻⁵ cm²/V·sec at an electric field of 4×10⁵ V/cm. In addition, the dependence (β) of the charge mobility on the electric field, which is defined below, is preferably not greater than 1.6×10⁻³.

To impart high photosensitivity to a photoreceptor, the content of the charge transport materials in the CTL is preferably not less than 70 phr. Suitable the charge transport materials include α-phenylstilbene compounds, benzidine compounds, monomers and dimmers of butadiene compounds and charge transport polymer materials having these structures in their main or side chains because of their high charge transportability.

The CTL can optionally include one or more additives such as antioxidants, plasticizers, lubricants and ultraviolet absorbents, if desired. Specific examples thereof are mentioned below. These additives are added in the CTL in an amount of from 0.1 to 20 phr, preferably from 0.1 to 10 phr. The leveling agents are added in an amount of from 0.001 to 0.1 phr.

Next, the protective layer will be explained.

The protective layer is an outermost layer formed on a photosensitive layer to improve an abrasion resistance and slidability of a photoreceptor. The protective layer includes at least a particulate fluorine-containing resin and a fluorochemical surfactant, wherein the particulate fluorine-containing resin is included therein in an amount of from 20 to 70% by volume based on total volume thereof; and a solid content of the fluorochemical surfactant is included therein in an amount of from 5 to 70% by weight based on total weight of a mixture of binder resins included therein.

Specific examples of the fluorine-containing resin for use in the protective layer include polytetrafluoroethylene (PTFE), tetrafluoroethylene/perfluoroalkylvinyl ether copolymers (PFA), tetrafluoroethylene/hexafluoropropylene copolymers (FEP), tetrafluoroethylene/hexafluoropropylene/perfluoroalkylvinyl ether copolymers (EPE), tetrafluoroethylene/ethylene copolymers (ETFE), polychlorotrifluoroethylene (PCTFE), chlorotrifluoroethylene/ethylene copolymers (ECTFE), polyvinylidenefluoride (PVDF) and polyvinylfluoride (PVF). Particularly, the polytetrafluoroethylene (PTFE), tetrafluoroethylene/perfluoroalkylvinyl ether copolymers (PFA) and tetrafluoroethylene/hexafluoropropylene copolymers (FEP) are preferably used because the resultant photoreceptor has a low surface friction coefficient and they have comparatively high ductility.

In the present invention, the protective layer needs to include the particulate fluorine-containing resin in an amount not less than 20% by volume based on total volume thereof such that the resultant photoreceptor has a low surface free energy. To maintain a low surface friction coefficient of the photoreceptor against repeated use for long periods regardless of an image forming apparatus using the photoreceptor, the protective layer preferably includes the particulate fluorine-containing resin in an amount not less than 35% by volume based on total volume thereof. Even when the protective layer includes the particulate fluorine-containing resin in an amount greater than 70% by volume, the low surface friction coefficient of the photoreceptor cannot be further maintained. The protective layer preferably includes the particulate fluorine-containing resin in an amount not greater than 70% by volume, otherwise the photoreceptor is difficult to have smooth surface when formed by a wet coating method.

The fluorine-containing resin can be pulverized and dispersed by a ball mill, a vibration mill, a sand mill, a KD mill, a three-roll mill, a pressure homogenizer, a liquid-collision disperser, a high-pressure jet disperser, a supersonic disperser, etc.

Since most of binder resins for use in the protective layer have high surface free energy when a commodity resin is used alone, the particulate fluorine-containing resin dispersed therein cannot be well spread.

Therefore, in the present invention, it is essential to include a fluorochemical surfactant in the protective layer such that the binder resin has a lower surface free energy than that of the fluorine-containing resin.

In many case, the fluorochemical surfactant is typically included in the protective layer in an amount not less than 5% by weight based on total weight of the binder resin to satisfy this condition.

In addition, a binding between the fluorine-containing resin and a mixture of binder resins is preferably from 35 mN/m to 60 mN/m to improve an abrasion resistance of the protective layer.

The fluorochemical surfactant is typically included in the protective layer in an amount not less than 5% by weight based on total weight of the binder resin to satisfy this condition.

Technologies to include a fluorine-containing resin and a fluorochemical surfactant in a photosensitive layer are disclosed in Japanese Laid-Open Patent Publications Nos. 5-66599, 5-88388, 6-332215, 6-332219, 6-282093, 8-87125, 11-212289, 2002-72510, etc.

However, in these publications, a fluorochemical dispersant is just supplementarily used to realize dispersed stability of the particulate fluorine-containing resin in a coating liquid. Therefore, a dosage of the dispersant in any of the publications is insufficient to improve an abrasion resistance of the resultant photoreceptor.

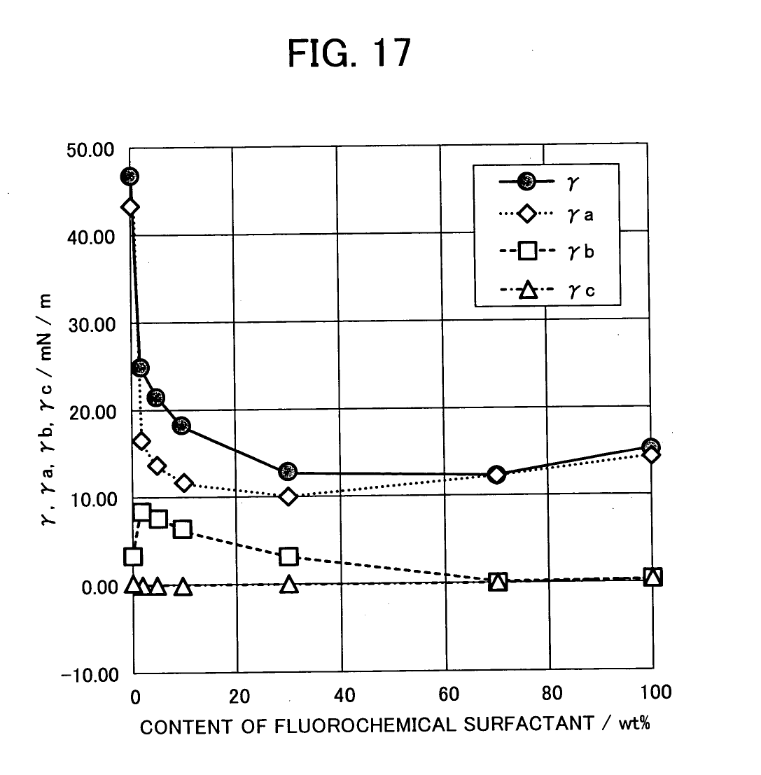

FIG. 17 is a diagram representing a relationship between a fluorochemical surfactant (Modiper F210 from NOF Corp.) and a surface free energy (γ) in a mixture of binder resins including the fluorochemical surfactant and polycarbonate (Panlite TS2050 from TEIJIN CHEMICALS LTD.), wherein γ a represents a variance component of the surface free energy, γ b represents a dipole anisotropy and γ c represents a hydrogen-bonded component. A surface free energy of tetrafluoroethylene/perfluoroalkylvinyl ether copolymers (PFA) was 31.2 mN/m.

Then, to substantially lower a surface free energy of the binder resin than that of the particulate fluorine-containing resin, a content of the fluorochemical surfactant is preferably not less than 5% by weight based on total weight of the binder resin.

Known fluorochemical surfactants can be used in the present invention. Specific examples of the fluorochemical surfactants include (1) copolymers including (metha)acrylate having a fluoroalkyl group disclosed in paragraph [0017] of Japanese Laid-Open Patent Publication No. 07-068398, such as block copolymers formed of a vinyl monomer not including a fluorine atom and a vinyl monomer including a fluorine atom disclosed in Japanese Laid-Open Patent Publications Nos. 60-221410 and 60-228588; and (2) fluorinated graft polymers such as comb graft polymers copolymerized with a methacrylate macro monomer having polymethylmethacrylate in its side chain and (metha)acrylate having a fluoroalkyl group disclosed in Japanese Laid-Open Patent Publication No. 60-187921. Specific examples of fluorine-containing block copolymers include block copolymers formed of a polymer segment including a fluorinated alkyl group and an acrylic polymer segment, such as a marketed Modiper F series from NOF Corp., e.g., F100, F110, F200, f210 and F2020. Specific examples of the fluorinated graft polymers include Aron Gf-150 and GF-300 marketed by TOAGOSEI CO., LTD. These fluorochemical surfactants can be used alone and can be also used as a crosslinking resin. Particularly, copolymers between methacrylate and fluoroalkyl acrylate are effectively used in the present invention.

Suitable resins for use in the protective layer include binder resins mentioned above for use in the CGL and charge transport polymers mentioned above.

When a thermoplastic resin is used for the protective layer, it is preferable that the protective layer is formed in such a manner that there is no interface between the protective layer and the underlying photosensitive layer (or CTL). Such a structure can be formed by using a resin which can be mixed with the resin in the underlying layer for the protective layer.

When the protective layer is formed, the following relationship is preferably satisfied:
1.3<W1/W2<1.9,
wherein W1 represents the weight of the protective layer, which is measured after coating the protective layer coating liquid and allowing the coated liquid to settle for 1 hour under conditions of 25±3° C. and 53±5% RH; and W2 represents the weight of the protective layer, which is measured after coating the protective layer coating liquid and drying the coated liquid upon application of heat thereto. This is because the charge transport material included in the photosensitive layer properly diffuses into the protective layer and thereby a charged carrier induced in the photosensitive layer by imagewise light can be fully injected into the protective layer.

A thickness of the charge transport layer including a fluorine-containing resin is a depth (D) including the fluorine-containing resin from a surface toward a substrate of a photoreceptor.

The depth (D) including the fluorine-containing resin preferably does not fluctuate much to produce quality images. Specifically, when 20 depths (D) including the fluorine-containing resin of a cross-sectional picture of a photosensitive layer are photographed by a SEM at a magnification of 2,000 times at an interval of 5 μm, a standard deviation of D is preferably not greater than ⅕ of an average of D, and more preferably not greater than 1/7 of an average of D to produce quality images.

To prepare such a charge transport layer including a fluorine-containing resin, the fluorine-containing resin in a coating liquid preferably has a volume-average particle diameter less than 1 μm.

In the present invention, the volume-average particle diameter of the fluorine-containing resin in a coating liquid is measured by a typical method using an ultracentrifugal automatic particle-diameter distribution measurer CAPA-700 from Horiba, Ltd.

When a crosslinking resin is used for the protective layer, it is preferable that a charge transporting group is incorporated in the crosslinking resin or a charge transport polymer is included in the protective layer. It is also possible that a low-molecular-weight charge transport material is included in the protective layer in combination with a crosslinking resin. However, in this case a bleeding problem often occurs such that the low-molecular-weight charge transport material bleeds from the protective layer. In this case, using a charge transport polymer material can prevent the low-molecular-weight charge transport material from bleeding.

Specific examples of the crosslinking resins for use in the present invention include urea resins, urethane resins, melamine resins, alkyd resins, etc.

When a fluorochemical surfactant having a reactive hydroxyl group or the above-mentioned charge transportable segments having the formula (1) to (6) are directly introduced into the crosslinking resins, the resultant photoreceptor can have a lower surface free energy or a higher sensitivity. Particularly, the melamine resins are preferably used as the crosslinking resins.

The protective layer effectively includes a filler to improve its abrasion resistance. Specific examples of the filler for use in the protective layer include titanium oxide, silica, silicone rubbers, alumina, zinc oxide, zirconium oxide, tin oxide, ITO, indium oxide, antimony oxide, magnesium oxide, silicon nitride, boron nitride, calcium oxide, calcium carbonate, barium sulfate, etc. In particular, silica and α-alumina are preferably used because of having good charge properties and good durability improving effect. The tin oxide and ITO are preferably used to impart a charge receptivity to the protective layer.

The filler may be subjected to a surface treating agent for the purpose of improving dispersibility thereof in a coating liquid and a coated layer. Specific examples of typical surface treating agents include silane coupling agents, silazane, titanate coupling agents, aluminium coupling agents, zircoaluminate coupling agents, zirconium organic compounds, fatty acid compounds. In addition, a surface of the filler may be subjected to an inorganic material such as alumina, zirconia, tin oxide and silica. Particularly, the fatty acid compounds and silane coupling agents are preferably used not only to improve dispersibility of the filler but also to reduce a residual potential of the resultant photoreceptor.

The filler can be pulverized and dispersed by a ball mill, a vibration mill, a sand mill, a KD mill, a three-roll mill, a pressure homogenizer, a liquid-collision disperser, a high-pressure jet disperser, a supersonic disperser, etc.

When many inorganic fillers having large particle diameters are present in the protective layer, the inorganic fillers project from a surface thereof and damage a cleaner, resulting in poor cleaning. Therefore, when the inorganic fillers are pulverized and dispersed by the above-mentioned methods, the inorganic fillers preferably have an average particle diameter less than 1 μm. When the inorganic fillers are pulverized more than necessary, the inorganic fillers re-agglutinate in a dispersion process thereof, resulting in production of particles having quite a large average particle diameter in quite many cases. Therefore, the inorganic fillers preferably have an average particle diameter not less than 0.1 μm.

The filler surface can be treated by known methods such as coating methods, mechanochemical methods, topochemical methods, encapsulation methods, high-energy methods, precipitaion methods, etc.

Although a content of the filler for use in the protective layer depends on a kind thereof, the content thereof is typically from 2 to 10% by weight based on total weight of solid contents in the protective layer in the present invention. In many case, the more the content of the filler, the better an abrasion resistance of the protective layer. However, when the filler is included therein in a large amount, continuousness of a low surface friction coefficient of the resultant photoreceptor deteriorated in many cases. Therefore, in the present invention, a content of the filler needs to be determined in a range wherein the continuousness of a low surface friction coefficient is guaranteed.

To reduce an irradiated part potential of a photoreceptor, a resistivity decreasing agent can be contained in the protective layer. Specific examples of the resistivity decreasing agent include polyhydric alcohols partially esterified with fatty acids (e.g., mono esters of sorbitan with fatty acids, esters of pentaerythritol with fatty acids, etc.), adducts of aliphatic alcohols with ethylene oxide, adducts of fatty acids with ethylene oxide, adducts of alkyl phenols with ethylene oxide, adducts of ethylene oxides with polyhydric alcohols partially esterified with fatty acids, carboxylic acid derivatives, etc. Particularly, the carboxylic acid derivatives are effectively used to reduce an irradiated part potential of a photoreceptor.

A coating liquid for the protective layer is prepared by mixing a fluorine-containing resin, a fluorochemical surfactant and a binder resin in a proper solvent. The fluorine-containing resin and a filler are optionally dispersed therein.

Suitable solvents for use in preparing the protective layer coating liquid include the ketone solvents, ether solvents, aromatic solvents, halogen-containing solvents, and ester solvents, mentioned above for use in the CTL coating liquid. Particularly, methyl ethyl ketone, tetrahydrofuran and cyclohexanone are more preferably used than chlorobenzene, dichloromethane, toluene and xylene because of their low environmental burdens.

Suitable coating method for use in forming the protective layer include the coating methods mentioned above for use in forming the CTL. In particular, spray coating methods and ring coating methods are preferably used because a protective layer having the desired properties can be stably produced.

As disclosed in paragraph [0014] of Japanese Laid-Open Patent Publication No. 6-95415, when the particulate fluorine-containing resin is included in a photosensitive layer in an amount greater than 50% by weight, it is considered that transportability a photoinduced charge carrier decreases and sensitivity of a photoreceptor deteriorates. Therefore, the protective layer preferably has a thickness such that a charge transportability thereof is not rate-limiting to a sensitivity of the resultant photoreceptor.

The protective layer preferably has a thickness of from 1 to 10 μm, and more preferably from 2 to 5 μm although depending on its formulation. The protective layer preferably has a thickness not less than 1 μm, and more preferably not less than 2 μm to maintain a low surface friction coefficient of the resultant photoreceptor.

On the other hand, when the protective layer becomes thick, a residual potential accumulates in accordance with the Poisson equation and a late charge carrier stagnates therein to form a space charge therein. Consequently, the resultant photoreceptor produces images having low image density or abnormal images such as negative or positive residual images.

Therefore, the protective layer needs to have a thickness such that a space charge formed therein does not substantially affect the resultant images. For example, the thickness of the protective layer can be determined by the following guideline. When an absolute value of a variation (VL/Ted) of an irradiated part potential (VL) of a photoreceptor to a time (Ted) between an irradiation process and a development process is greater than 0.7 V/msec, the photoreceptor produces abnormal images in many cases. Therefore, the protective layer needs to have a thickness such that the absolute value of a variation is less than 0.7 V/msec.

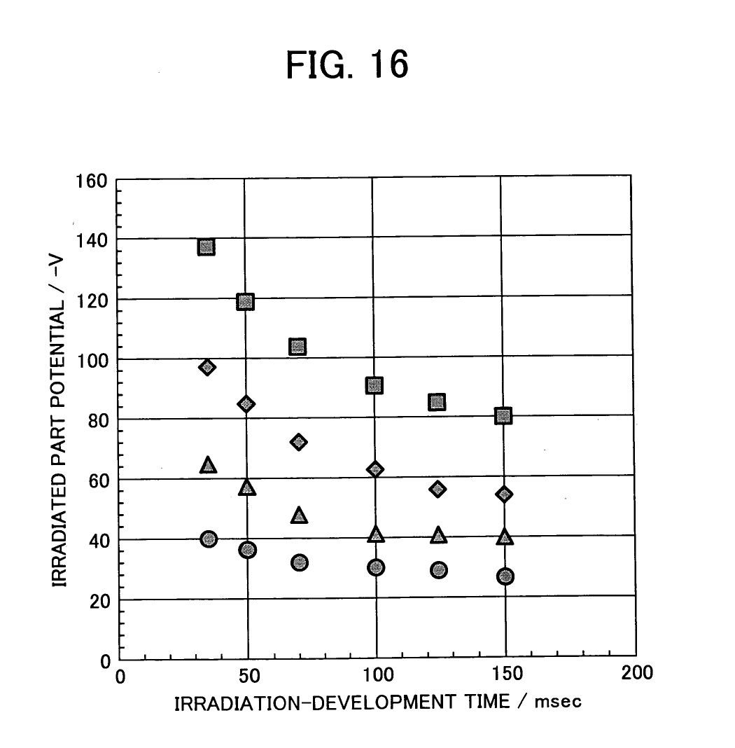

Typically, the shorter the Ted, the larger the absolute value of a variation (VL/Ted) of the irradiated part potential. The longer the Ted, the smaller the VL/Ted. These are shown in FIG. 16. The Ted is preferably determined when the VL/Ted is smaller, and the protective layer preferably has a thickness such that the absolute value of a variation is less than 0.7 V/msec, and more preferably less than 0.2 V/msec. The thickness thereof satisfying this is typically from 2 to 10 μm.

If desired, the protective layer can include additives such as antioxidants, plasticizers, ultraviolet absorbents, and leveling agents. The additives are mentioned below, and can be used alone or in combination.

Next, the charge transport layer including a fluorine-containing resin will be explained.

The charge transport layer including a fluorine-containing resin in the present invention includes at least a charge transport material, a binder resin, a particulate fluorine-containing resin and a fluorochemical surfactant, and is a part of CTL formed on a surface side of a photoreceptor, having a charge transportability and maintaining a low surface friction coefficient thereof. In addition, the charge transport layer including a fluorine-containing resin include the particulate fluorine-containing resin in an amount of from 20 to 70% by volume based on total volume thereof; and a solid content of the fluorochemical surfactant is included therein in an amount of from 5 to 70% by weight based on total weight of a mixture of binder resins included therein.

The charge transport layer including a fluorine-containing resin has a high charge transportability equal to that of a conventional CTL and is distinguished from the protective layer. In addition, the charge transport layer including a fluorine-containing resin is used as a surface layer of a functionally-separated CTL having two or more layers in a multilayered photoreceptor. Namely, this layer is used together with the charge transport layer not including the fluorine-containing resin, and is not used alone. Therefore, this is different from a single-layered CTL wherein the fluorine-containing resin as an additive is uniformly dispersed therein.

The charge transport layer including a fluorine-containing resin preferably has a thickness not less than 1 μm, and more preferably not less than 2 μm to maintain a low surface friction coefficient of the resultant photoreceptor.

On the other hand, when the charge transport layer including a fluorine-containing resin becomes thick, a residual potential accumulates in accordance with the Poisson equation and a late charge carrier stagnates therein to form a space charge therein. Consequently, the resultant photoreceptor produces images having low image density or abnormal images such as negative or positive residual images.

Therefore, the charge transport layer including a fluorine-containing resin needs to have a thickness such that a space charge formed therein does not substantially affect the resultant images. Similarly to the protective layer, the charge transport layer including a fluorine-containing resin needs to have a thickness such that the absolute value of a variation is less than 0.7 V/msec.

The single-layered CTL uniformly including a large amount of the fluorine-containing resin causes a large deterioration of sensitivity and an increase of residual potential of the resultant photoreceptor in many cases. However, the functionally-separated CTL can easily avoid deterioration of electrostatic properties thereof.

A ratio (N/P) of a thickness (N) of the charge transport layer including a fluorine-containing resin to a thickness (P) of the charge transport layer not including a fluorine-containing resin is preferably from 0.0125 to 0.67

Suitable solvents for use in preparing the charge transport layer including a fluorine-containing resin coating liquid include the ketone solvents, ether solvents, aromatic solvents, halogen-containing solvents, and ester solvents, mentioned above for use in the CTL coating liquid. Particularly, methyl ethyl ketone, tetrahydrofuran and cyclohexanone are more preferably used than chlorobenzene, dichloromethane, toluene and xylene because of their low environmental burdens.

As the binders for use in the charge transport layer including a fluorine-containing resin, the polymer compounds used in the CTL not including the charge transport layer including a fluorine-containing resin can be used. These polymer compounds can be used alone or in combination, and the polymer compounds copolymerized with a charge transport material can also be used. Particularly, polycarbonate resins, polyester resins and polyarylate resins are effectively used because of their high transparency and good mechanical strength.

When a thermoplastic resin is used in the charge transport layer including a fluorine-containing resin, the thermoplastic resins is preferably soluble with (or the same as) that of the charge transport layer not including the fluorine-containing resin so as not to form an interface therebetween when the charge transport layer including a fluorine-containing resin is formed thereon.

Most of the binder resins for use in the charge transport layer including a fluorine-containing resin do not have much affinity with the fluorine-containing resin, and the charge transport layer including a fluorine-containing resin including a large amount thereof has a mechanical burden brittleness. Therefore, the charge transport layer including a fluorine-containing resin including a large amount thereof can have a low friction coefficient and continuousness thereof to some extent, however, an abrasion speed thereof increases due to repeated use for long periods as an adverse effect.

Therefore, in the present invention, it is essential to include a fluorochemical surfactant in the charge transport layer including a fluorine-containing resin such that the binder resin has a lower surface free energy than that of the fluorine-containing resin therefor to have an abrasion resistance more than predetermined even though including a large amount of the fluorine-containing resin. In addition, a binding between the fluorine-containing resin and a mixture of binder resins is preferably from 35 mN/m to 60 mN/m to improve an abrasion resistance of thereof.

A content and a material of the fluorochemical surfactant are the same as those of the protective layer. The above-mentioned conditions of the charge transport materials therein are scarcely changed.

The charge transport layer including a fluorine-containing resin can include a filler to improve its abrasion resistance. In organic fillers for use therein include those used in the protective layer. In particular, silica and a-alumina are effectively used because of having stable electrostatic properties and maintaining smoothness of the resultant photoreceptor.

The filler may be subjected to a surface treating agent for the purpose of improving dispersibility thereof in a coating liquid and a coated layer as mentioned above. Particularly, the fatty acid compounds and silane coupling agents are preferably used not only to improve dispersibility of the filler but also to improve electrostatic properties of the resultant photoreceptor.

To reduce an irradiated part potential of a photoreceptor, a resistivity decreasing agent can be used together with the inorganic filler in the charge transport layer including a fluorine-containing resin. The resistivity decreasing agent can be used alone or in combination. The resistivity decreasing agent is preferably included in an amount of 0.5 to 10 parts by weight, per 100 parts by weight of the inorganic filler. When less than 0.5 parts by weight, an effect thereof is small and unpractical.

The filler can be pulverized and dispersed by a ball mill, a vibration mill, a sand mill, a KD mill, a three-roll mill, a pressure homogenizer, a liquid-collision disperser, a high-pressure jet disperser, a supersonic disperser, etc.

When many inorganic fillers having large particle diameters are present in the protective layer, the inorganic fillers project from a surface thereof and damage a cleaner, resulting in poor cleaning. Therefore, when the inorganic fillers are pulverized and dispersed by the above-mentioned methods, the inorganic fillers preferably have an average particle diameter less than 1 μm. When the inorganic fillers are pulverized more than necessary, the inorganic fillers re-agglutinate in a dispersion process thereof, resulting in production of particles having quite a large average particle diameter in quite many cases. Therefore, the inorganic fillers preferably have an average particle diameter not less than 0.1 μm.

Although a content of the filler for use in the charge transport layer including a fluorine-containing resin depends on a kind thereof, the content thereof is typically 10% by weight based on total weight of solid contents in the charge transport layer including a fluorine-containing resin in the present invention. In many case, the more the content of the filler, the better an abrasion resistance of the charge transport layer including a fluorine-containing resin. However, when the filler is included therein in a large amount, continuousness of a low surface friction coefficient of the resultant photoreceptor deteriorated in many cases. Therefore, in the present invention, a content of the filler needs to be determined in a range wherein the continuousness of a low surface friction coefficient is guaranteed.

The same charge transport materials and content thereof used in the CTL not including the charge transport layer including a fluorine-containing resin can be used in the charge transport layer including a fluorine-containing resin.

When a charge transport material included in the CTL not including a filler is different from that included in the charge transport layer including a fluorine-containing resin, the charge transport material included in each layer preferably has a small ionization potential. Specifically, not greater than 0.15 eV. When two or more kinds of charge transport materials are included in the charge transport layer including a fluorine-containing resin, a difference in ionization potential between the two or more kinds of charge transport materials is preferably not greater than 0.15 eV.

When the resultant photoreceptor is required to have a quick response, it is advantageous that the charge transport layer including a fluorine-containing resin has a high charge transportability, and further, it is preferable therefor to have sufficiently high transportability even in a low electric field area.

The charge transport layer including a fluorine-containing resin can optionally include one or more low-molecular-weight compounds and leveling agents such as antioxidants, plasticizers, lubricants and ultraviolet absorbents. The low-molecular-weight compounds are added therein in an amount of from 0.1 to 50 parts by weight, preferably from 0.1 to 20 parts by weight based on total weight of resins included therein. The leveling agents are added in an amount of from 0.001 to 5 parts by weight based thereon.

The charge transport layer including a fluorine-containing resin can be formed by a dip coating method, a spray coating method, a ring coating method, a roll coating method, a gravure coating method, a nozzle coating method and a screen printing method. In particular, the spray coating method and ring coating method are preferably used because a charge transport layer including a fluorine-containing resin having desired properties can be stably produced.

The charge transport layer including a fluorine-containing resin and charge transport layer not including a fluorine-containing resin thereunder preferably have a continuous layer structure without a distinct separation except for presence of the fluorine-containing resin. Such a layer structure can prevent the charge transport layer including a fluorine-containing resin from peeling, which is effectively used for downsizing a diameter of a drum-shaped photoreceptor in particular. In addition, an electric interface barrier can be prevented. Therefore, an increase of an irradiated part potential of the photoreceptor can effectively be prevented.

A thickness of the charge transport layer including a fluorine-containing resin is a depth (D) including the fluorine-containing resin from a surface toward a substrate of a photoreceptor.

The depth (D) including the fluorine-containing resin preferably does not fluctuate much to produce quality images. Specifically, when 20 depths (D) including the fluorine-containing resin of a cross-sectional picture of a photosensitive layer are photographed by a SEM at a magnification of 2,000 times at an interval of 5 μm, a standard deviation of D is preferably not greater than ⅕ of an average of D, and more preferably not greater than 1/7 of an average of D to produce quality images.

A charge transport layer including a fluorine-containing resin coating liquid satisfying the following conditions can prepare a charge transport layer including a fluorine-containing resin having such a layer structure:

(1) a coating solvent can fully dissolve a resin for use in the charge transport layer including a fluorine-containing resin coating liquid;

(2) when the charge transport layer including a fluorine-containing resin coating liquid is formed, the following relationship is preferably satisfied:
1.3<W1/W2<1.9,
wherein W1 represents the weight of the protective layer, which is measured after coating the protective layer coating liquid and allowing the coated liquid to settle for 1 hour; and

(3) the fluorine-containing resin in the coating liquid has a volume-average particle diameter less than 1 μm.

The charge transport layer including a fluorine-containing resin coating liquid satisfying the conditions (1) to (3) can form an advantageous charge transport layer including a fluorine-containing resin for higher durability of the resultant photoreceptor.

To atomize the fluorine-containing resin in the coating liquid, the fluorine-containing resin needs to have a small primary particle diameter, and further, a supersonic is effectively applied thereto in many cases.

Next, the mixed-type photosensitive layer will be explained.

The mixed-type photosensitive layer in the present invention is a photosensitive layer wherein a charge generation material and a charge transport material are dispersed together.

The mixed-type photosensitive layer not including a fluorine-containing resin can be formed by dissolving or dispersing a binder resin, a charge generation material and a charge transport material in a proper solvent to prepare a coating liquid; and coating and drying the coating liquid.

The binder resins, charge generation materials and charge transport materials mentioned above can be used.

Suitable solvents include the solvents mentioned above. Particularly, methyl ethyl ketone, tetrahydrofuran and cyclohexanone are more preferably used than chlorobenzene, dichloromethane, toluene and xylene because of their low environmental burdens.

The photosensitive layer can optionally include one or more low-molecular-weight compounds and leveling agents such as antioxidants, plasticizers, lubricants and ultraviolet absorbents. The low-molecular-weight compounds are added therein in an amount of from 0.1 to 20 phr, preferably from 0.1 to 10 phr. The leveling agents are added in an amount of from 0.001 to 0.1 phr.

The mixed-type photosensitive layer can be formed by a dip coating method, a spray coating method, a ring coating method, a roll coating method, a gravure coating method, a nozzle coating method and a screen printing method. Typically, the dip coating method, spray coating method and ring coating method are preferably used.

The mixed-type photosensitive layer preferably has a thickness of from 5 to 50 μm, and more preferably from 10 to 35 μm. When the resultant photoreceptor is required to produce images having a high image resolution, the thickness is preferably from 10 to 28 μm.

Next, the mixed-type photosensitive layer including a fluorine-containing resin will be explained.

The mixed-type photosensitive layer including a fluorine-containing resin in the present invention includes at least a charge transport material, a binder resin, a particulate fluorine-containing resin and a fluorochemical surfactant, and is a part of CTL formed on a surface side of a photoreceptor, having a charge transportability and maintaining a low surface friction coefficient thereof. In addition, the mixed-type photosensitive layer including a fluorine-containing resin include the particulate fluorine-containing resin in an amount of from 20 to 70% by volume based on total volume thereof; and a solid content of the fluorochemical surfactant is included therein in an amount of from 5 to 70% by weight based on total weight of a mixture of binder resins included therein.

The mixed-type photosensitive layer including a fluorine-containing resin has a high charge transportability equal to that of a conventional CTL and is distinguished from the protective layer. In addition, the mixed-type photosensitive layer including a fluorine-containing resin is used as a surface layer of a functionally-separated CTL having two or more layers in a multilayered photoreceptor. Namely, this layer is used together with the charge transport layer not including the fluorine-containing resin, and is not used alone. Therefore, this is different from a single-layered CTL wherein the fluorine-containing resin as an additive is uniformly dispersed therein.

The mixed-type photosensitive layer including a fluorine-containing resin can be formed by the same method of forming the above-mentioned charge transport layer including a fluorine-containing resin.

The binder resins, charge generation materials, charge transport materials, fluorine-containing resin and fluorochemical surfactants mentioned above can be used.

Suitable solvents used for coating include the solvents mentioned above.

The coating methods include a dip coating method, a spray coating method, a ring coating method, a roll coating method, a gravure coating method, a nozzle coating method and a screen printing method. Typically, the spray coating method is preferably used to prevent the fluorine-containing resin from agglutinating when coated.

The mixed-type photosensitive layer including a fluorine-containing resin preferably has a thickness not less than 1 μm, and more preferably not less than 2 μm such that the resultant photoreceptor maintains a low surface friction coefficient against repeated use for long periods.

Typically, a ratio (N/P) of a thickness (N) of the mixed-type photosensitive layer including a fluorine-containing resin to a thickness (P) of the charge transport layer not including a fluorine-containing resin is preferably from 0.0125 to 0.67.

In the photo receptor of the present invention, an undercoat layer can be formed between the substrate and the photosensitive layer or the CGL to improve adhesion between the substrate and the photosensitive layer; to prevent formation of moiré; to improve the coating property of the overlying layer; to reduce the residual potential; and to prevent injection of charges from the substrate into the photosensitive layer.

The undercoat layer typically includes a resin as a main component. Since a photosensitive layer is typically formed on the undercoat layer by coating a liquid including an organic solvent, the resin in the undercoat layer preferably has good resistance to general organic solvents. Specific examples of such resins include water-soluble resins such as polyvinyl alcohol resins, case in and polyacrylic acid sodium salts; alcohol soluble resins such as nylon copolymers and methoxymethylated nylon resins; and thermosetting resins capable of forming a three-dimensional network such as polyurethane resins, melamine resins, alkyd-melamine resins, epoxy resins and the like.

The undercoat layer may include a fine powder of metal oxides such as titanium oxide, silica, alumina, zirconium oxide, tin oxide and indium oxide.

The undercoat layer can also be formed by coating a coating liquid using a proper solvent and a proper coating method mentioned above for use in the photosensitive layer.

In addition, metal oxide layers formed by a sol-gel method using a silane coupling agent, titanium coupling agent or a chromium coupling agent can also be used as the undercoat layer.

Further, a layer of aluminum oxide which is formed by an anodic oxidation method and a layer of an organic compound such as polyparaxylylene or an inorganic compound such as SiO, SnO2, TiO2, ITO or CeO2 which is formed by a vacuum evaporation method is also preferably used as the undercoat layer.

The thickness of the undercoat layer is preferably 0.1 to 5 μm.

In the photoreceptor of the present invention, additives such as antioxidants, plasticizers, lubricants, ultraviolet absorbents, low molecular weight charge transport materials and leveling agents can be used in respective layers thereof to improve the gas barrier property of the outermost layer of the photoreceptor and the stability thereof to withstand environmental conditions.

Suitable antioxidants for use in the layers of the photoreceptor include the following compounds but are not limited thereto.

(a) Phenolic Compounds

2,6-di-t-butyl-p-cresol, butylated hydroxyanisole, 2,6-di-t-butyl-4-ethylphenol, n-octadecyl-3-(4′-hydroxy-3′,5′-di-t-butylphenol), 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)b enzene, tetrakis-[methylene-3-(3′,5′-di-t-butyl-4′-hydroxyphenyl)pr opionate]methane, bis[3,3′-bis(4′-hydroxy-3′-t-butylphenyl)butyric acid]glycol ester, tocophenol compounds, and the like.

(b) Paraphenylenediamine Compounds

N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′-dimethyl-N,N′-di-t-butyl-p-phenylenediamine, and the like.

(c) Hydroquinone Compounds

2,5-di-t-octylhydroquinone, 2,6-didodecylhydroquinone, 2-dodecylhydroquinone, 2-dodecyl-5-chlorohydroquinone, 2-t-octyl-5-methylhydroquinone, 2-(2-octadecenyl)-5-methylhydroquinone and the like.

(d) Organic Sulfur-Containing Compounds

dilauryl-3,3′-thiodipropionate, distearyl-3,3′-thiodipropionate, ditetradecyl-3,3′-thiodipropionate, and the like.

(e) Organic Phosphorus-Containing Compounds

triphenylphosphine, tri(nonylphenyl)phosphine, tri(dinonylphenyl)phosphine, tricresylphosphine, tri(2,4-dibutylphenoxy)phosphine and the like.

Suitable plasticizers for use in the layers of the photoreceptor include the following compounds but are not limited thereto:

(a) Phosphoric Acid Esters

triphenyl phosphate, tricresyl phosphate, trioctyl phosphate, octyldiphenyl phosphate, trichloroethyl phosphate, cresyldiphenyl phosphate, tributyl phosphate, tri-2-ethylhexyl phosphate, triphenyl phosphate, and the like.

(b) Phthalic Acid Esters

dimethyl phthalate, diethyl phthalate, diisobutyl phthalate, dibutyl phthalate, diheptyl phthalate, di-2-ethylhexyl phthalate, diisooctyl phthalate, di-n-octyl phthalate, dinonyl phthalate, diisononyl phthalate, diisodecyl phthalate, diundecyl phthalate, ditridecyl phthalate, dicyclohexyl phthalate, butylbenzyl phthalate, butyllauryl phthalate, methyloleyl phthalate, octyldecyl phthalate, dibutyl fumarate, dioctyl fumarate, and the like.

(c) Aromatic Carboxylic Acid Esters

trioctyl trimellitate, tri-n-octyl trimellitate, octyl oxybenzoate, and the like.

(d) Dibasic Fatty Acid Esters

dibutyl adipate, di-n-hexyl adipate, di-2-ethylhexyl adipate, di-n-octyl adipate, n-octyl-n-decyl adipate, diisodecyl adipate, dialkyl adipate, dicapryl adipate, di-2-etylhexyl azelate, dimethyl sebacate, diethyl sebacate, dibutyl sebacate, di-n-octyl sebacate, di-2-ethylhexyl sebacate, di-2-ethoxyethyl sebacate, dioctyl succinate, diisodecyl succinate, dioctyl tetrahydrophthalate, di-n-octyl tetrahydrophthalate, and the like.

(e) Fatty Acid Ester Derivatives

butyl oleate, glycerin monooleate, methyl acetylricinolate, pentaerythritol esters, dipentaerythritol hexaesters, triacetin, tributyrin, and the like.

(f) Oxyacid Esters

methyl acetylricinolate, butyl acetylricinolate, butylphthalylbutyl glycolate, tributyl acetylcitrate, and the like.

(g) Epoxy Compounds

epoxydized soybean oil, epoxydized linseed oil, butyl epoxystearate, decyl epoxystearate, octyl epoxystearate, benzyl epoxystearate, dioctyl epoxyhexahydrophthalate, didecyl epoxyhexahydrophthalate, and the like.

(h) Dihydric Alcohol Esters

diethylene glycol dibenzoate, triethylene glycol di-2-ethylbutyrate, and the like.

(i) Chlorine-Containing Compounds

chlorinated paraffin, chlorinated diphenyl, methyl esters of chlorinated fatty acids, methyl esters of methoxychlorinated fatty acids, and the like.

(j) Polyester Compounds

polypropylene adipate, polypropylene sebacate, acetylated polyesters, and the like.

(k) Sulfonic Acid Derivatives

p-toluene sulfonamide, o-toluene sulfonamide, p-toluene sulfoneethylamide, o-toluene sulfoneethylamide, toluene sulfone-N-ethylamide, p-toluene sulfone-N-cyclohexylamide, and the like.

(1) Citric Acid Derivatives

triethyl citrate, triethyl acetylcitrate, tributyl citrate, tributyl acetylcitrate, tri-2-ethylhexyl acetylcitrate, n-octyldecyl acetylcitrate, and the like.

(m) Other Compounds

terphenyl, partially hydrated terphenyl, camphor, 2-nitro diphenyl, dinonylnaphthalene, methyl abietate, and the like.

Suitable lubricants for use in the layers of the photoreceptor include the following compounds but are not limited thereto.

(a) Hydrocarbons

liquid paraffins, paraffin waxes, micro waxes, low molecular weight polyethylenes, and the like.

(b) Fatty Acids

lauric acid, myristic acid, palmitic acid, stearic acid, arachidic acid, behenic acid, and the like.

(c) Fatty Acid Amides

Stearic acid amide, palmitic acid amide, oleic acid amide, methylenebisstearamide, ethylenebisstearamide, and the like.

(d) Ester Compounds

lower alcohol esters of fatty acids, polyhydric alcohol esters of fatty acids, polyglycol esters of fatty acids, and the like.

(e) Alcohols

cetyl alcohol, stearyl alcohol, ethylene glycol, polyethylene glycol, polyglycerol, and the like.

(f) Metallic Soaps

lead stearate, cadmium stearate, barium stearate, calcium stearate, zinc stearate, magnesium stearate, and the like.

(g) Natural Waxes

Carnauba wax, candelilla wax, beeswax, spermaceti, insect wax, montan wax, and the like.

(h) Other Compounds

silicone compounds, fluorine compounds, and the like.

Suitable ultraviolet absorbing agents for use in the layers of the photoreceptor include the following compounds but are not limited thereto.

(a) Benzophenone Compounds

2-hydroxybenzophenone, 2,4-dihydroxybenzophenone, 2,2′,4-trihydroxybenzophenone, 2,2′,4,4′-tetrahydroxybenzophenone, 2,2′-dihydroxy-4-methoxybenzophenone, and the like.

(b) Salicylate Compounds

phenyl salicylate, 2,4-di-t-butylphenyl-3,5-di-t-butyl-4-hydroxybenzoate, and the like.

(c) Benzotriazole Compounds

(2′-hydroxyphenyl)benzotriazole, (2′-hydroxy-5′-methylphenyl)benzotriazole, (2′-hydroxy-3′-t-butyl-5′-methylphenyl)-5-chlorobenzotriazole, and the like.

(d) Cyano Acrylate Compounds

ethyl-2-cyano-3,3-diphenyl acrylate, methyl-2-carbomethoxy-3-(paramethoxy) acrylate, and the like.

(e) Quenchers (Metal Complexes)

nickel(2,2′-thiobis(4-t-octyl)phenolate)-n-butylamine, nickeldibutyldithiocarbamate, cobaltdicyclohexyldithiophosphate, and the like.

(f) HALS (Hindered Amines)

bis(2,2,6,6-tetramethyl-4-piperidyl)sebacate, bis(1,2,2,6,6-pentamethyl-4-piperidyl)sebacate, 1-[2-{3-(3,5-di-t-butyl-4-hydroxyphenyl)propionyloxy}ethyl]-4-{3-(3,5-di-t-butyl-4-hydroxyphenyl)propionyloxy}-2,2,6,6-tetrametylpyridine, 8-benzyl-7,7,9,9-tetramethyl-3-octyl-1,3,8-triazaspiro[4,5]undecane-2,4-dione, 4-benzoyloxy-2,2,6,6-tetramethylpiperidine, and the like.

Specific examples of the low-molecular-weight charge transport materials include the charge transport materials mentioned above for use in the CGL.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

First, the measuring methods for use in the present invention will be explained.

(1) Binding and Surface Free Energy

A plate-shaped fluorine-containing resin powder was prepared by pressurizing fluorine-containing resin powder with a pellet tablet machine to measure a contact angle thereof. A mixture of binder resins (before crosslinked when crosslinked resins) was dissolved in tetrahydrofuran to prepare a solution; coating the solution on an aluminium plate with a doctor blade; and drying the solution thereon upon application of heat at 150° C. for 30 min to measure a contact angle of the mixture of binder resins.

The contact angles were measured by an automatic contact angle measurer CA-W from Kyowa Interface Science Co., LTD. As a standard material, ion-exchanged water, methylene iodide and a-bromonaphthalene were selected.

Bases on measured contact angles and surface free energy data (Table 1) of the three standard materials, a binding among the standard materials, plate-shaped fluorine-containing resin and mixture of binder resins was determined using the following formula:
W_{solid liquid}=γ_{liquid}(1+cos θ)

TABLE 1

| | γ | γ ^{a} | γ ^{b} | γ ^{c} |
|---|---|---|---|---|
| Liquid | (mN/m) | (mN/m) | (mN/m) | (mN/m) |
| Ion-exchanged water | 72.8 | 29.1 | 1.3 | 42.4 |
| α-bromonaphthalene | 44.6 | 44.4 | 0.2 | 0 |
| Methylene iodide | 50.8 | 46.8 | 4.0 | 0 |

γ: surface free energy
γ ^{a}: variance component of the surface free energy
γ ^{b}: dipole anisotropy
γ ^{c}: hydrogen-bonded component

Next, a binding among the methylene iodide, α-bromonaphthalene, plate-shaped fluorine-containing resin and mixture of binder resins, and the following formula were used to make a simultaneous equation.

$${W}_{12} = 2 \sqrt{{γ}_{1}^{a} \cdot {γ}_{2}^{a}} + 2 \sqrt{{γ}_{1}^{b} \cdot {γ}_{2}^{b}} + 2 \sqrt{{γ}_{1}^{c} \cdot {γ}_{2}^{c}}$$

wherein γ₁^{a} and γ₁^{a} a were based on the above-mentioned data.

Then, √γ^{a} and √γ^{b} of the plate-shaped fluorine-containing resin and mixture of binder resins were determined.

Next, a binding between the ion-exchanged water and a photoreceptor, and the formula W_{solid liquid}=γ_{liquid}(1+cos θ) were used to determine √γ^{c} of the plate-shaped fluorine-containing resin and mixture of binder resins.

From the √γ^{a}, √γ^{b}, √^{c} and the formula

$${W}_{12} = 2 \sqrt{{γ}_{1}^{a} \cdot {γ}_{2}^{a}} + 2 \sqrt{{γ}_{1}^{b} \cdot {γ}_{2}^{b}} + 2 \sqrt{{γ}_{1}^{c} \cdot {γ}_{2}^{c}} ,$$

a surface free energy of the photoreceptor was determined.
γ=γ^{a}+γ^{b}+γ^{c}

A binding between the plate-shaped fluorine-containing resin and mixture of binder resins was determined by assign the values determined as above to the formula

$${W}_{12} = 2 \sqrt{{γ}_{1}^{a} \cdot {γ}_{2}^{a}} + 2 \sqrt{{γ}_{1}^{b} \cdot {γ}_{2}^{b}} + 2 \sqrt{{γ}_{1}^{c} \cdot {γ}_{2}^{c}} .$$

(2) Thickness

The thickness of a drum-shaped photoreceptor was measured by an overcurrent-type film thickness measurer (FISCHER SCOPE mms from FISCHER) at an interval of 1 cm in the longitudinal direction thereof, and an average of the thickness was determined as a thickness of the photosensitive layer.

(3) Friction Coefficient

The friction coefficient of a photoreceptor was measured by a method disclosed in paragraph [0047] of Japanese Laid-Open Patent Publication No. 2001-201899. Namely, a belt-shaped middle-thickness bond paper which was cut such that the paper mill direction is the longitudinal direction was contacted to ¼ of an outer circumference. After a load of 100 g was applied to an end thereof and a force gauge was connected to the other end thereof, the force gauge was moved a at a constant speed, and a value of the force gauge when the belt-shaped middle-thickness bond paper started moving was used to determine the friction coefficient by the following formula:
μs=2/π×1n (F/W)
wherein μs is a static friction coefficient, F is a value of force gauge (g) and W is a load (100 g).
(4) Fluorine Atom Coverage Over Surface of Photoreceptor

A scanning X-ray photoelectron spectroscope (Quantum 2000 from PHI was used under the following conditions to prepare mapping data of the fluorine atom on the surface of a photoreceptor. An area coverage thereof shown in the mapping data was determined by an image analysis software (Image-Pro Plus from Mediacybernetics).

X-ray source: Al Kα (monochrome)

Analyzed surface area: 100 μm×100 μm

Mapping analyzed area: 1,000 μm×500 μm

Others: A neutralization gun was used

(5) Surface Potential of Photoreceptor

A surface potential of the center of a photoreceptor was measured by a modified developing unit having a probe of a surface electrometer (Trek MODEL 344 from Trek) installed at an image developer in a copier.

(6) Surface Roughness of Photoreceptor

A centerline surface roughness Ra (JIS-'82 standard) of a drum-shaped photoreceptor was measured by a stylus surface roughness gauge Surfcom (from Tokyo Seimitsu Co., Ltd,) having a pickup E-DT-S02A therefrom.

Next, a preparation example of the toner for use in the present invention will be explained.

Preparation for Polyester

A condensation reaction was performed between 690 parts of an adduct of bisphenol A with 2 moles of ethyleneoxide and 230 parts of terephthalic acid in a reaction vessel including a cooling pipe, a stirrer and a nitrogen inlet pipe at 210° C. for 10 hrs under a normal pressure and nitrogen stream to prepare a reaction product. Further, after the reaction product was reacted while dehydrated under a depressure by 10 to 15 mm Hg for another 5 hrs, the reaction product was cooled to 160° C. Then, 18 parts of phthalic anhydride were added thereto and was reacted for 2 hrs to prepare an unmodified polyester (a) having a weight-average molecular weight of 85,000.

Preparation for Prepolymer

A condensation reaction was performed among 800 parts of an adduct of bisphenol A with 2 moles of ethyleneoxide, 160 parts of isophthalic acid, 60 parts of terephthalic acid and 2 parts of dibutyltinoxide in a reaction vessel including a cooling pipe, a stirrer and a nitrogen inlet pipe at 230° C. for 8 hrs under a normal pressure and nitrogen stream to prepare a reaction product. Further, after the reaction product reacted while dehydrated under a depressure by 10 to 15 mm Hg for another 5 hrs, the reaction product was cooled to 160° C. Then, 32 parts of phthalic anhydride were added thereto and was reacted for 2 hrs. Next, the reaction product was cooled to 80° C. and was further reacted with 170 parts of isophoronediisocyanate in ethylacetate for 2 hrs prepare a prepolymer including an isocyanate group having a weight-average molecular weight of 35,000.

Preparation for Ketimine Compound

30 parts of isophorondiamine and 70 parts of methyl ethyl ketone were reacted at 50° C. for 5 hrs in a reaction vessel including a stirrer and a thermometer to prepare a ketimine compound.

Preparation for Toner

14.3 parts of the prepolymer, 55 parts of the polyester (a) and 78.6 parts of ethylacetate were stirred and dissolved in a beaker to prepare a solution. Next, 10 parts of rice wax which is a release agent having a melting point of 83° C. and 4 parts of copper phthalocyanine blue pigment were added thereto, and was stirred with a TK-type homomixer at 12,000 rpm for 20 min to prepare a mixed solution. Then, the mixed solution was pulverized with a beads mill for 40 min at 20° C. to prepare an oil dispersion of toner materials.

While 306 parts of ion-exchanged water, 265 parts of a suspension including 10% of tricalcium phosphate and 0.2 parts of sodium dodecylbenzenesulfonate were stirred in a beaker with a TK-type homomixer at 12,000 rpm to prepare a water dispersion, the oil dispersion of toner materials and 2.7 parts of the ketimine compound were added to the water dispersion to perform a urea reaction. After an organic solvent was removed from the dispersion liquid after the reaction under depressure within 1.0 hr at 50° C. or less, the dispersion liquid after the reaction was filtered, washed, dried and classified with a wind classifier to prepare a spheric mother toner (1).

100 parts of the mother toner and 0.25 parts of a charge controlling agent (Bontron E-84 from Orient Chemical Industries Co., Ltd.) were mixed with a Q-type mixer (from Mitsui Mining Co., Ltd.) at a peripheral speed (of its turbine-formed blade) of 50 m/sec to prepare a mixture. The mixing operation included 5 cycles of mixing for 2 min and pausing for 1 min.

Further, 0.7 parts of hydrophobic silica (H2000 from Clariant Japan KK) were mixed with the mixture, which included 5 cycles of mixing for 30 sec at a peripheral speed of 15 m/sec and pausing for 1 min, to prepare a cyan toner. The pigment colorant had an average dispersed particle diameter 5 μm. The toner had a circularity of 0.960. Hereinafter, the cyan toner is referred to as A toner.

### Example 1

Each of the following undercoat layer coating liquid, a CGL coating liquid and a CTL coating liquid was coated on an aluminum cylinder with a diameter of 90 mm and then dried to overlay an undercoat layer having a thickness of 4.0 μm, a CGL having a thickness of 0.3 μm, and a CTL having a thickness of 20 μm. Next, the protective layer coating liquid was coated on the CTL with a spray to form a protective layer having a thickness of 3 μm thereon to prepare an electrophotographic photoreceptor of the present invention. The protective layer coating liquid was dispersed with a vibration mill using a zirconia ball having a diameter of 2 mm.

Undercoat Layer Coating Liquid

| | |
|---|---|
| Alkyd resin (BEKKOZOL 1307-60-EL from | 10 |
| Dainippon Ink & Chemicals, Inc.) | |
| Melamine resin (SUPER BEKKAMIN G-821-60 | 7 |
| from Dainippon Ink & Chemicals, Inc.) | |
| Titanium dioxide | 40 |
| (CR-EL from Ishihara Sangyo Kaisha Ltd.) | |
| Methyl ethyl ketone | 200 |

CGL Coating Liquid

Trisazo pigment having the following formula: 3 (from Ricoh Company, Ltd.)

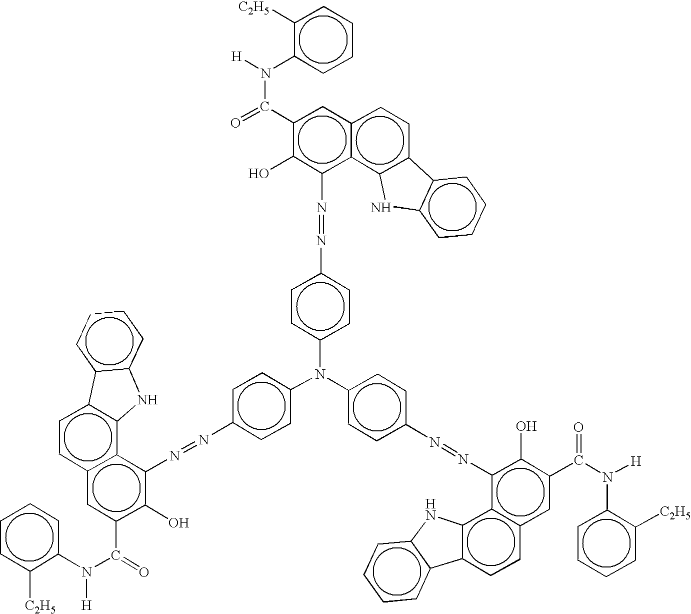

| | |
|---|---|
| Polyvinyl butyral | 1.2 |
| (XYHL from Union Carbide Corp.) | |
| Cyclohexanone | 200 |
| Methyl ethyl ketone | 80 |

CTL not Including a Fluorine-Containing Resin Coating Liquid

| | |
|---|---|
| Polycarbonate resin | 10 |
| (Panlite TS-2050 from Teijin Chemicals Ltd.) | |
| Low-molecular-weight | 8 |
| charge transport material | |
| having the following formula: | |
| 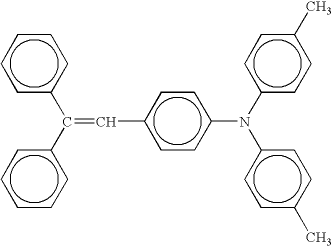 | |
| Tetrahydrofuran | 100 |
| 1% tetrahydrofuran solution of silicone oil | 1 |
| (KF50-100CS from Shin-Etsu Chemical Industry Co., Ltd.) | |

Protective Layer Coating Liquid

| | |
|---|---|
| Particulate fluorine-containing resin | 48.5 |
| (MPE-056 from DU PONT-MITSUI | |
| FLUOROCHEMICALS COMPANY, LTD.) | |
| Fluorochemical surfactant | 10 |
| (Modiper F210 from NOF Corp.) | (Solid content: 3) |
| Polycarbonate resin | 8.5 |
| (Panlite TS-050 from Teijin Chemicals Ltd.) | |
| Tetrahydrofuran | 2,500 |
| Cyclohexanone | 700 |

In the present invention, a volume ratio of the fluorine-containing resin in the protective layer is determined by dividing parts by weight thereof with a density thereof. Based on JIS K-7112, densities of outermost layer materials (a mixture of binder resins) excluding the particulate fluorine-containing resin for use in the present invention were determined as 1.18±0.03 (g/cc) . Densities of PFA and PTFE used as the particulate fluorine-containing resin were both determined as 2.15 (g/cc)

### Example 2

The procedure of preparation of the electrophotographic photoreceptor in Example 1 was repeated to prepare an electrophotographic photoreceptor except for replacing the protective layer coating liquid with the following protective layer coating liquid:

Protective Layer Coating Liquid

| | |
|---|---|
| Particulate fluorine-containing resin | 60 |
| (MPE-056 from DU PONT-MITSUI | |
| FLUOROCHEMICALS COMPANY, LTD.) | |
| Fluorochemical surfactant | 10 |
| (Modiper F210 from NOF Corp.) | (Solid content: 3) |
| Polycarbonate resin | 37 |
| (Panlite TS-050 from Teijin Chemicals Ltd.) | |
| Tetrahydrofuran | 2,500 |
| Cyclohexanone | 700 |

### Comparative Example 1

The procedure of preparation of the electrophotographic photoreceptor in Example 1 was repeated to prepare an electrophotographic photoreceptor except for replacing the protective layer coating liquid with the following protective layer coating liquid:

Protective Layer Coating Liquid

| | |
|---|---|
| Particulate fluorine-containing resin | 60 |
| (MPE-056 from DU PONT-MITSUI | |
| FLUOROCHEMICALS COMPANY, LTD.) | |
| Fluorochemical surfactant | 1 |
| (Modiper F210 from NOF Corp.) | (Solid content: 0.3) |
| Polycarbonate resin | 39.7 |
| (Panlite TS-050 from Teijin Chemicals Ltd.) | |
| Tetrahydrofuran | 2,500 |
| Cyclohexanone | 700 |

### Comparative Example 2

The procedure of preparation of the electrophotographic photoreceptor in Example 1 was repeated to prepare an electrophotographic photoreceptor except for replacing the protective layer coating liquid with the following protective layer coating liquid:

Protective Layer Coating Liquid

| | |
|---|---|
| Particulate fluorine-containing resin | 13 |
| (MPE-056 from DU PONT-MITSUI | |
| FLUOROCHEMICALS COMPANY, LTD.) | |
| Fluorochemical surfactant | 17 |
| (Modiper F210 from NOF Corp.) | (Solid content: 5.1) |
| Polycarbonate resin | 82 |
| (Panlite TS-050 from Teijin Chemicals Ltd.) | |
| Tetrahydrofuran | 2,500 |
| Cyclohexanone | 700 |

The protective layer coating conditions in Examples 1 and 2 and Comparative Examples 1 and 2 were as follows:

Coating liquid discharge amount: 15 ml/min

Coating liquid discharge pressure: 2.0 kgf/cm²

Rotation speed of the drum: 360 rpm

Coating speed: 24 mm/sec

Distance between spray head and drum: 5 cm

Number of coating: 4

Each of the thus prepared photoreceptors in Examples 1 and 2 and Comparative Examples 1 and 2 was installed in an electrophotographic image forming apparatus imagio Color 4055 from Ricoh Company, Ltd., which is equipped with a fluorine-containing resin spreading blade applying a linear pressure of 25 gf/cm onto a surface of the photoreceptor to perform a running test wherein each consecutive 5 copies of a rectangular solid image and an image of characters, totally 60,000 copies of each (cyan mono-color) image having an image area proportion of 5% were produced on copy papers TYPE 6000 from Ricoh Company, Ltd.

A developer used in imagio Color 4055 included an exclusive magnetic carrier therefor, and the A toner in an amount of 5% by weight.

A charging roller located close to the electrophotographic photoreceptor was used as a charger for the electrophotographic image forming apparatus. A distance between the photoreceptor and charging roller was 50 μm.

The charging conditions were as follows:

Voltage of AC component: 2 kV (peak to peak voltage)

Frequency of AC component: 1.3 kHz

Voltage of DC component: DC voltage was controlled so that the charged photoreceptor has a potential of −700 V.

Development bias: −500 V

Environmental conditions.: 24° C. 54% RH

Zinc stearate as a lubricant was removed from the electrophotographic image forming apparatus and the photoreceptor had a linear speed of 200 mm/sec, and no other modification was applied thereto.

After the running test, a surface friction coefficient of the photoreceptor was measured.

Further, the photoreceptor after the running test was subjected to an exposure in an atmosphere wherein NO gas had a concentration of 50 ppm and NO₂ gas of 15 ppm for 4 days. After the exposure, a halftone image having a graded image density of from 3 to 10% was produced using the photoreceptor to evaluate reproducibility thereof. The results are shown in Table 2.

TABLE 2

| | | Binding between particulate | | |
|---|---|---|---|---|
| | Surface free energy of | fluorine-containing resin and | | |
| | mixture of binder resins | mixture of binder resins | Friction | Halftone |
| | (mN/m) | (mN/m) | coefficient | image |
| Example 1 | 20.8 | 41.3 | 0.26 | Good |
| Example 2 | 19.9 | 40.3 | 0.20 | Good |
| Comparative | 35.9 | 56.7 | 0.38 | Low-density |
| Example 1 | | | | image was not |
| | | | | produced |
| Comparative | 20.9 | 41.5 | 0.42 | Good |
| Example 2 | | | | |

The particulate fluorine-containing resin (MPE-056 from DU PONT-MITSUI FLUOROCHEMICALS COMPANY, LTD.) used in Examples 1 and 2 and Comparative Examples 1 and 2 was a tetrafluoroethylene/perfluoroalkylvinyl ether copolymer (PFA), and the particulate fluorine-containing resin had a surface free energy of 31.2 mN/m. A content thereof in an outermost layer of the photoreceptor was 70% by volume in Example 1, 45% by volume in Example 2, 45% by volume in Comparative Example 1 and 8% by volume in Comparative Example 2 respectively. The protective layer including the fluorochemical surfactant in an amount not less than 5% by weight based on total weight of binder resin therein in each Example 1 and Example 2 had a lower surface free energy than the particulate fluorine-containing resin, a low friction coefficient even after the running test and good quality images were produced until the running test was finished. In contrast, the protective layer in each Comparative Example 1 and Comparative Example 2 had a high friction coefficient after the running test and cleanability thereof deteriorated.

In Comparative Example 1, a content of the fluorochemical surfactant is low and a surface free energy of the mixture of binder resins is high. A content of the particulate fluorine-containing resin is low in Comparative Example 2. It is considered that these are reasons of the high friction coefficient.

The photoreceptor in each Example 1, Example 2 and Comparative Example 2 subjected to the exposure in an atmosphere of oxidizing gases produced a halftone image having good quality. It is considered that this is because the fluorochemical surfactant enhances gas resistance of the photoreceptor.

### Example 3

Each of the following undercoat layer coating liquid, a CGL coating liquid and a CTL coating liquid was coated on an aluminum cylinder with a diameter of 30 mm and then dried to overlay an undercoat layer having a thickness of 3.5 μm, a CGL having a thickness of 0.2 μm, and a CTL not including a fluorine-containing resin and having a thickness of 23 μm. Next, the following protective layer coating liquid was coated thereon with a spray to form a protective layer having a thickness of 7 μm thereon to prepare an electrophotographic photoreceptor.

Undercoat Layer Coating Liquid

| | |
|---|---|
| Alkyd resin solution (BEKKOLITE M6401-50 | 12 |
| from Dainippon Ink & Chemicals, Inc.) | |
| Melamine resin solution | 8 |
| (SUPER BEKKAMIN G-821-60 from Dainippon Ink & | |
| Chemicals, Inc.) | |
| Titanium dioxide | 40 |
| (CR-EL from Ishihara Sangyo Kaisha Ltd.) | |
| Methyl ethyl ketone | 200 |

CGL Coating Liquid

Bisazo pigment having the following formula: 5 (from Ricoh Company, Ltd.)

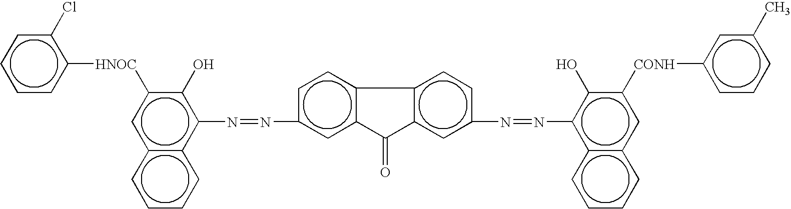

| | |
|---|---|
| Polyvinyl butyral | 1 |
| (XYHL from Union Carbide Corp.) | |
| Cyclohexanone | 200 |
| Methyl ethyl ketone | 80 |

CTL not Including a Fluorine-Containing Resin Coating Liquid

| | |
|---|---|
| Polycarbonate resin | 9 |
| (Panlite TS-2050 from Teijin Chemicals Ltd.) | |
| Low-molecular-weight | 8 |
| charge transport material | |
| having the following formula: | |
| 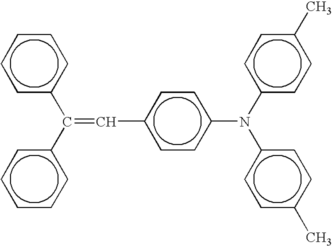 | |
| Tetrahydrofuran | 100 |
| 1% tetrahydrofuran solution of silicone oil | 1 |
| (KF50-100CS from Shin-Etsu Chemical Industry Co., Ltd.) | |

Protective Layer Coating Liquid

| | |
|---|---|
| Particulate fluorine-containing resin | 60 |
| (MPE-056 from DU PONT-MITSUI | |
| FLUOROCHEMICALS COMPANY, LTD.) | |
| Fluorochemical surfactant | 33 |
| (Modiper F210 from NOF Corp.) | (Solid content: 9.9) |
| Polycarbonate resin | 30 |
| (Panlite TS-050 from Teijin Chemicals Ltd.) | |
| Tetrahydrofuran | 2,500 |
| Cyclohexanone | 700 |

### Example 4

The procedure of preparation of the electrophotographic photoreceptor in Example 3 was repeated to prepare an electrophotographic photoreceptor except for replacing the protective layer coating liquid with the following CTL including a fluorine-containing resin coating liquid:

When the CTL including a fluorine-containing resin coating liquid was prepared, a fluorine-containing resin dispersion liquid dispersed with a vibration mill using a zirconia ball having a diameter of 2 mm was previously prepared. Separately, a solution including a charge transport material and a resin was prepared, and the fluorine-containing resin dispersion liquid and solution were mixed and stirred to prepare the CTL including a fluorine-containing resin coating liquid.

CTL Including a Fluorine-Containing Resin Coating Liquid

| | |
|---|---|
| Low-molecular-weight | 15 |
| charge transport material | |
| having the following formula: | |
| 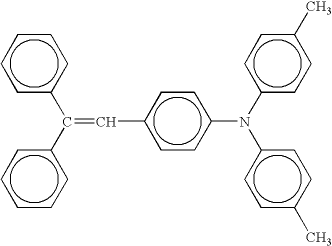 | |
| Particulate fluorine-containing resin | 60 |
| (MPE-056 from DU PONT-MITSUI | |
| FLUOROCHEMICALS COMPANY, LTD.) | |
| Fluorochemical surfactant | 10 |
| (Modiper F210 from NOF Corp.) | (Solid content: 3) |
| Polycarbonate resin | 22 |
| (Panlite TS-050 from Teijin Chemicals Ltd.) | |
| Tetrahydrofuran | 2,500 |
| Cyclohexanone | 700 |

### Example 5

The procedure of preparation of the electrophotographic photoreceptor in Example 3 was repeated to prepare an electrophotographic photoreceptor except for replacing the protective layer with the following CTL including a fluorine-containing resin coating liquid:

CTL Including a Fluorine-Containing Resin Coating Liquid

| | |
|---|---|
| Charge transport polymer material | 37 |
| having the following formula: | |
| (weight average molecular weight of 110,000) | |
| 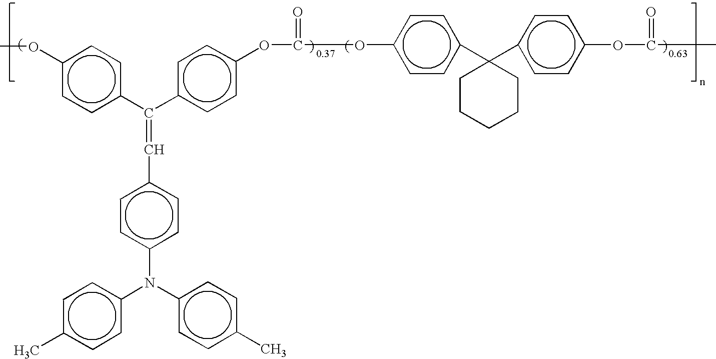 | |
| (n represents the repeat number) | |
| Particulate fluorine-containing resin | 60 |
| (MPE-056 from DU PONT-MITSUI FLUOROCHEMICALS COMPANY, LTD.) | |
| Fluorochemical surfactant | 10 |
| Modiper F210 from NOF Corp.) | Solid content: 3) |
| Tetrahydro furan | 3,250 |
| Cyclohexanone | 910 |

### Comparative Example 3

The procedure of preparation of the electrophotographic photoreceptor in Example 3 was repeated to prepare an electrophotographic photoreceptor except for replacing the CTL including a fluorine-containing resin coating liquid with the following CTL including a fluorine-containing resin coating liquid:

CTL Including a Fluorine-Containing Resin Coating Liquid

| | |
|---|---|
| Low-molecular-weight | 15 |
| charge transport material | |
| having the following formula: | |
| 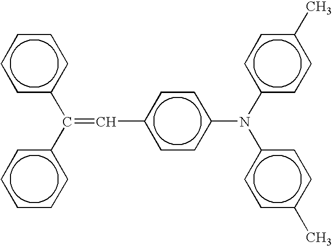 | |
| Particulate fluorine-containing resin | 60 |
| (MPE-056 from DU PONT-MITSUI | |
| FLUOROCHEMICALS COMPANY, LTD.) | |
| Fluorochemical surfactant | 1 |
| (Modiper F210 from NOF Corp.) | (Solid |
| | content: 0.33) |
| Polycarbonate resin | 22 |
| (Panlite TS-050 from Teijin Chemicals Ltd.) | |
| Tetrahydrofuran | 2,500 |
| Cyclohexanone | 700 |

The CTL including a fluorine-containing resin coating conditions in Examples 3 to 5 and Comparative Example 3 were as follows:

Coating liquid discharge amount: 15 ml/min

Coating liquid discharge pressure: 2.0 kgf/cm²

Rotation speed of the drum: 120 rpm

Coating speed: 24 mm/sec

Distance between spray head and drum: 5 cm

Number of coating: 3

Each of the thus prepared photoreceptors in Examples 3 to 5 and Comparative Example 3 was installed in a partially-modified electrophotographic image forming apparatus IPSiO Color 8100 from Ricoh Company, Ltd. to perform a running test wherein each consecutive 5 copies of a text image and a graphic image having a pixel density of 600 dpi×600 dpi, totally 20,000 copies of each image having an image area proportion of 5% were produced on copy papers TYPE 6000 from Ricoh Company, Ltd. 280 g of a developer including the a ferrite carrier coated with silicone, having an average particle diameter of 40 μm, and A toner in an amount of 5% by weight was used in each developing station unit of the electrophotographic image forming apparatus.

A charging roller located close to the electrophotographic photoreceptor was used as a charger for the electrophotographic image forming apparatus. A distance between the photoreceptor and charging roller was 50 μm.

The charging conditions were as follows:

Voltage of AC component: 1.5 kV (peak to peak voltage)

Frequency of AC component: 0.9 kHz

Voltage of DC component: DC voltage was controlled so that the charged photoreceptor has a potential of −700 V.

Development bias: −500 V

Environmental conditions: 24° C. 54% RH

The electrophotographic image forming apparatus did not have a discharger and the photoreceptor had a linear speed of 125 mm/sec, and a genuine cleaner thereof was used.

When the running test was finished, 10 copies of a halftone image having a pixel density of 1200 dpi×1200 dpi and an image area proportion of 5% were produced. Next, a surface of the photoreceptor the cleaning blade passed through was observed with a microscope to classify the cleanability into 5 grades. In addition, after a black solid image having a pixel density of 1200 dpi×1200 dpi was produced on a copy paper, a halftone image having a pixel density of 1200 dpi×1200 dpi was produced on the same copy paper to classify a residual image thereon into 5 grades.

Cleanability

5: No residual toner. The photoreceptor has a glossy surface. Image quality is not affected.

4:As light residual toner. The photoreceptor has a glossy surface. Image quality is not affected.

3: A slight residual toner and the photoreceptor has slightly a dim surface. Image quality is not affected.

2: A residual toner is observed and the photoreceptor has a dim surface. Image is slightly contaminated.

1: Toner filming is observed. Abnormal images such as white spotted images and foggy images were produced. Not usable.

Residual Image

5: No residual image is observed.

4: A very minor degree of residual image is observed.

3: A minor degree of residual image is observed but the image is still acceptable.

2: Some degree of residual image is observed.

1: A considerable degree of residual image is observed and therefore the images have problem.

In addition, an abrasion amount of the photoreceptor was measured when the running test was finished.

The results are shown in Table 3.

TABLE 3

| | | Binding between | | | |
|---|---|---|---|---|---|
| | Surface free | particulate | | | |
| | energy of | fluorine-con- | | | |
| | mixture of | taining resin | Abrasion | | |
| | binder resins | and mixture of | amount | Residual | cleana- |
| | (mN/m) | binder resins (mN/m) | (μm) | image | bility |
| Example 3 | 14.3 | 35.3 | 4.9 | 3 | 3 |
| Example 4 | 17.8 | 38.2 | 4.2 | 4 | 3 |
| Example 5 | 16.1 | 39.8 | 3.8 | 4 | 3 |
| Comparative | 32.3 | 53.3 | 3.4 | 3 | 2 |
| Example 3 | | | | | |

The particulate fluorine-containing resin used in Examples 3 to 5 and Comparative Example 3 had a surface free energy of 31.2 mN/m. The surface free energies of the binder resins for use in the protective layer in Example 3 and CTLs including a fluorine-containing resin in Examples 4 and 5 are smaller than the surface free energy of the particulate fluorine-containing resin. In contrast, this is revere in Comparative Example 3. Cleanability in Examples 3 and 4 are much better than that of Comparative Example 3.

The residual image in each Example 4 and Example 5 wherein the CTL including a fluorine-containing resin is a surface layer of the photoreceptor was improved much more than that in Example 3.

### Example 6

The procedures for preparation and evaluation of the electrophotographic photoreceptor in Example 3 were repeated to prepare and evaluate an electrophotographic photoreceptor except for further installing an exclusive blade spreading the fluorine-containing resin projected from a surface of the photoreceptor in the electrophotographic image forming apparatus, which has a similar shape to the cleaning blade and applies a pressure of 10 gf/cm to the surface thereof. The cleanability improved to 4. A coverage of the fluorine-containing resin over the surface of the photoreceptor was measured and an area occupation of the fluorine atoms was 33%.

### Example 7

Each of the following undercoat layer coating liquid, a CGL coating liquid and a CTL coating liquid was coated on an aluminum cylinder with a diameter of 30 mm and then dried to overlay an undercoat layer having a thickness of 3.5 μm, a CGL having a thickness of 0.2 μm, and a CTL not including a fluorine-containing resin and having a thickness of 22 μm. Next, the following CTL including a fluorine-containing resin coating liquid was coated thereon with a spray to form CTL including a fluorine-containing resin having a thickness of 4 μm thereon to prepare an electrophotographic photoreceptor.

When the CTL including a fluorine-containing resin coating liquid was prepared, a fluorine-containing resin dispersion liquid dispersed with a vibration mill using a zirconia ball having a diameter of 2 mm was previously prepared. Separately, a solution including A resin was prepared, and the fluorine-containing resin dispersion liquid and solution were mixed and stirred to prepare the CTL including a fluorine-containing resin coating liquid. The particulate fluorine-containing resin dispersed therein had an average particle diameter of 3.2 μm.

Undercoat Layer Coating Liquid

| | |
|---|---|
| Alkyd resin solution (BEKKOLITE M6401-50 | 12 |
| from Dainippon Ink & Chemicals, Inc.) | |
| Melamine resin solution | 8 |
| (SUPER BEKKAMIN G-821-60 from Dainippon Ink & | |
| Chemicals, Inc.) | |
| Titanium dioxide | 40 |
| (CR-EL from Ishihara Sangyo Kaisha Ltd.) | |
| Methyl ethyl ketone | 200 |

CGL Coating Liquid

| | |
|---|---|
| Titanylphthalocyanine | 9 |
| (from Ricoh Company, Ltd.) | |
| Polyvinyl butyral | 5 |
| (XYHL from Union Carbide Corp.) | |
| Methyl ethyl ketone | 400 |

CTL not Including a Fluorine-Containing Resin Coating Liquid

| | |
|---|---|
| Polycarbonate resin | 10 |
| (Panlite TS-2050 from Teijin Chemicals Ltd.) | |
| Low-molecular-weight | 9 |
| charge transport material | |
| having the following formula: | |
| 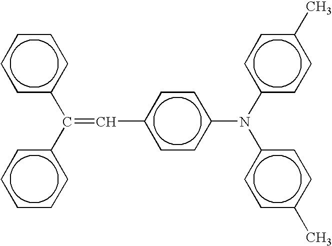 | |
| Tetrahydrofuran | 100 |
| 1% tetrahydrofuran solution of silicone oil | 1 |
| (KF50-100CS from Shin-Etsu Chemical Industry Co., Ltd.) | |

CTL Including a Fluorine-Containing Resin Coating Liquid

| | |
|---|---|
| Particulate fluorine-containing resin | 60 |
| (MPE-056 from DU PONT-MITSUI | |
| FLUOROCHEMICALS COMPANY, LTD.) | |
| Fluorochemical surfactant | 10 |
| (Modiper F210 from NOF Corp.) | (Solid content: 3) |
| Polycarbonate resin (Panlite | 37 |
| TS-050 from Teijin Chemicals Ltd.) | |
| Tetrahydrofuran | 2,500 |
| Cyclohexanone | 700 |

### Example 8

The procedure for preparation of the electrophotographic photoreceptor in Example 7 was repeated to prepare an electrophotographic photoreceptor except for dispersing the fluorine-containing resin dispersion with a zirconia ball having a diameter of 1 mm to prepare the CTL including a fluorine-containing resin coating liquid wherein the fluorine-containing resin had an average particle diameter of 0.95 μm.

Each of the thus prepared photoreceptors in Examples 7 and 38 was installed in a partially-modified electrophotographic image forming apparatus imagio Neo 270 from Ricoh Company, Ltd. to perform a running test wherein each consecutive 5 copies of a text image, totally 20,000 copies of each image having an image area proportion of 6% were produced on copy papers TYPE 6000 from Ricoh Company, Ltd.

Genuine toner and developer for imagio Neo 270 were used therein.

A charging roller located close to the electrophotographic photoreceptor was used as a charger for the electrophotographic image forming apparatus. A distance between the photoreceptor and charging roller was 50 μm.

The charging conditions were as follows:

Voltage of AC component: 1.5 kV (peak to peak voltage)

Frequency of AC component: 0.9 kHz

Voltage of DC component: DC voltage was controlled so that the charged photoreceptor has a potential of −700 V.

Development bias: −500 V

Environmental conditions: 24° C. 54% RH

The electrophotographic image forming apparatus did not have a discharger and a process cartridge for imagio Neo 270 was used except for changing the charger into the charging roller, and the photoreceptor had a linear speed of 150 mm/sec.

The surface roughness and background fouling of the produced images before and after the running test were evaluated. The background fouling was judged in comparison with a grade sample and classified into the following 5 grades:

5: No background fouling was observed.

4: Background fouling was slightly observed, but the image quality was good.

3: Background fouling was slightly observed, but the image quality was substantially good.

2: Background fouling was observed, but the image quality was not a problem in practical use.

1: Background fouling was observed, but the image quality was a problem in practical use.

The results are shown in Table 4.

TABLE 4

| | | Binding between | | |
|---|---|---|---|---|
| | Surface free | particulate | | |
| | energy of | fluorine-con- | | |
| | mixture of | taining resin | | |
| | binder resins | and mixture of | Surface | Background |
| | (mN/m) | binder resins (mN/m) | roughness | fouling |
| Example 7 | 20.8 | 41.3 | 0.16 | 5 |
| | | | (before test) | (before test) |
| | | | 0.22 | 3 |
| | | | (after test) | (after test) |
| Example 8 | 20.8 | 41.3 | 0.09 | 5 |
| | | | (before test) | (before test) |
| | | | 0.11 | 4 |
| | | | (after test) | (after test) |

When the CTL including a fluorine-containing resin coating liquid wherein the fluorine-containing resin had a small average particle diameter was used, the resultant photoreceptor had a small surface roughness. The smaller the surface roughness, the less the background fouling.

### Example 9

Each of the following undercoat layer coating liquid, a CGL coating liquid and a CTL coating liquid was coated on an aluminum cylinder with a diameter of 30 mm and then dried to overlay an undercoat layer having a thickness of 3.5 μm, a CGL having a thickness of 0.3 μm, and a CTL having a thickness of 22 μm. Next, the protective layer coating liquid was coated on the CTL with a spray to form a protective layer having a thickness of 5 μm thereon to prepare an electrophotographic photoreceptor of the present invention. The protective layer coating liquid was dispersed with a vibration mill using a zirconia ball having a diameter of 2 mm.

Undercoat Layer Coating Liquid

| | |
|---|---|
| Alkyd resin | 10 |
| (BEKKOZOL 1307-60-EL from Dainippon | |
| Ink & Chemicals, Inc.) | |
| Melamine resin | 7 |
| (SUPER BEKKAMIN G-821-60 from Dainippon | |
| Ink & Chemicals, Inc.) | |
| Titanium dioxide | 40 |
| (CR-EL from Ishihara Sangyo Kaisha Ltd.) | |
| Methyl ethyl ketone | 200 |

CGL Coating Liquid

| | |
|---|---|
| Bisazo pigment having the following formula: | 5 |
| (from Ricoh Company, Ltd.) | |
| 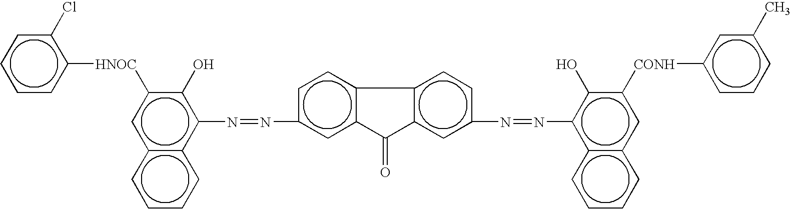 | |
| Polyvinyl butyral | 1 |
| (XYHL from Union Carbide Corp.) | |
| Cyclohexanone | 200 |
| Methyl ethyl ketone | 80 |

CTL not Including a Fluorine-Containing Resin Coating Liquid

| | |
|---|---|
| Polycarbonate resin | 10 |
| (Panlite TS-2050 from Teijin Chemicals Ltd.) | |
| Low-molecular-weight | 7 |
| charge transport material | |
| having the following formula: | |
| 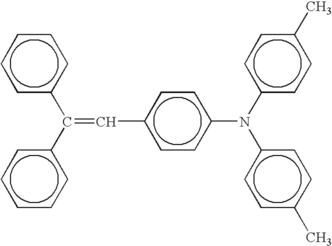 | |
| Tetrahydrofuran | 100 |
| 1% tetrahydrofuran solution of silicone oil | 1 |
| (KF50-100CS from Shin-Etsu Chemical Industry Co., Ltd.) | |

Protective Layer Coating Liquid

| | |
|---|---|
| Particulate fluorine-containing resin | 55 |
| (MPE-056 from DU PONT-MITSUI | |
| FLUOROCHEMICALS COMPANY, LTD.) | |
| Fluorochemical surfactant | 10 |
| (Modiper F210 from NOF Corp.) | (Solid content: 3) |
| Polycarbonate resin (Panlite | 42 |
| TS-050 from Teijin Chemicals Ltd.) | |
| Tetrahydrofuran | 2,500 |
| Cyclohexanone | 700 |

### Example 10

The procedure of preparation of the electrophotographic photoreceptor in Example 9 was repeated to prepare an electrophotographic photoreceptor except for replacing the protective layer coating liquid with the following protective layer coating liquid:

Protective Layer Coating Liquid

| | |
|---|---|
| Particulate fluorine-containing resin | 55 |
| (MPE-056 from DU PONT-MITSUI | |
| FLUOROCHEMICALS COMPANY, LTD.) | |
| Fluorochemical surfactant | 10 |
| (Aron GF-300 from Toagosei Co., Ltd.) | (Solid content: 3) |
| Polycarbonate resin | 42 |
| (Z-polyca from Teijin Chemicals Ltd. | |
| having a viscosity-average molecular | |
| weight of 50,000) | |
| Tetrahydrofuran | 2,500 |
| Cyclohexanone | 700 |

### Example 11

The procedure of preparation of the electrophotographic photoreceptor in Example 9 was repeated to prepare an electrophotographic photoreceptor except for replacing the protective layer coating liquid with the following protective layer coating liquid:

Protective Layer Coating Liquid

| | |
|---|---|
| Particulate fluorine-containing resin | 55 |
| (MPE-056 from DU PONT-MITSUI | |
| FLUOROCHEMICALS COMPANY, LTD.) | |
| Fluorochemical surfactant | 10 |
| (Modiper F210 from NOF Corp.) | (Solid content: 3) |
| Polystyrene resin (Denkastyrol | 42 |
| HRM-3 from Denki Kagaku Kogyo K.K.) | |
| Tetrahydrofuran | 2,500 |
| Cyclohexanone | 700 |

Each of the thus prepared photoreceptors in Examples 9 to 11 was installed in a partially-modified electrophotographic image forming apparatus IPSiO Color 8100 from Ricoh Company, Ltd. to perform a running test wherein each consecutive 5 copies of a text image and a graphic image having a pixel density of 600 dpi×600 dpi, totally 20,000 copies of each image having an image area proportion of 5% were produced on copy papers TYPE 6000 from Ricoh Company, Ltd. 280 g of a developer including the a ferrite carrier coated with silicone, having an average particle diameter of 40 μm, and A toner in an amount of 5% by weight was used in each developing station unit of the electrophotographic image forming apparatus.

A charging roller located close to the electrophotographic photoreceptor was used as a charger for the electrophotographic image forming apparatus. A distance between the photoreceptor and charging roller was 50 μm.

The charging conditions were as follows:

Voltage of AC component: 1.5 kV (peak to peak voltage)

Frequency of AC component: 0.9 kHz

Voltage of DC component: DC voltage was controlled so that the charged photoreceptor has a potential of −700 V.

Development bias: −500 V

Environmental conditions: 24° C. 54% RH

The electrophotographic image forming apparatus did not have a discharger and the photoreceptor had a linear speed of 125 mm/sec, and a genuine cleaner thereof was used.

When the running test was finished, 10 copies of a halftone image having a pixel density of 1200 dpi×1200 dpi and an image area proportion of 5% were produced. Next, a surface of the photoreceptor the cleaning blade passed through was observed with a microscope to classify the cleanability into 5 grades. In addition, an abrasion amount of the surface thereof after the test was measured.

The results are shown in Table 5.

TABLE 5

| | | Binding between | | |
|---|---|---|---|---|
| | Surface free | particulate | | |
| | energy of | fluorine-con- | | |
| | mixture of | taining resin | Abrasion | |
| | binder resins | and mixture of | amount | Cleana- |
| | (mN/m) | binder resins (mN/m) | (μm) | bility |
| Example 9 | 20.4 | 40.8 | 3.9 | 4 |
| Example 10 | 12.5 | 35.3 | 4.9 | 4 |
| Example 11 | 18.9 | 40.0 | 4.8 | 4 |

The fluorochemical surfactant used in the protective layer in Example 9 is a block copolymer of methacrylate and fluoroalkyl acrylate, while the fluorochemical surfactant in Example 10 is a fluorinated comb graft polymer. It is considered that the binding between the particulate fluorine-containing resin and mixture of binder resins was affected by this difference of the fluorochemical surfactant. Both had good cleanability, but Example 9 had a much better abrasion resistance.

Further, to evaluate the protective layer coating liquids in Examples 9 and 10, a change of each thereof when stored while stirred was observed. The protective layer coating liquid in Example 10 tended to foam as time passed, and the protective layer coating liquid in Example 9 also tended to foam as time, but not so much as Example 10.

Example 11 wherein the binder resin in the protective layer was changed from polycarbonate in Example 9 to polystyrene has a larger abrasion amount than Example 9. Namely, the polycarbonate is more preferably used than polystyrene as he binder resin in the protective layer.

### Example 12

The procedure of preparation of the electrophotographic photoreceptor in Example 9 was repeated to prepare an electrophotographic photoreceptor except for replacing the protective layer coating liquid with the following CTL including a fluorine-containing resin coating liquid:

CTL including a fluorine-containing resin coating liquid

| | |
|---|---|
| Low-molecular-weight | 2 |
| charge transport material | |
| having the following formula: | |

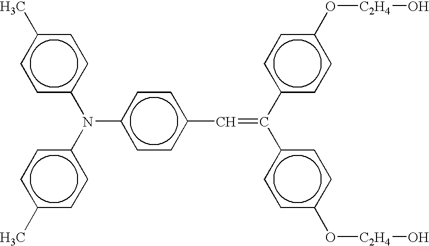

| | |
|---|---|
| Particulate fluorine-containing resin | 10 |
| (MPE-056 from DU PONT-MITSUI FLUOROCHEMICALS | |
| COMPANY, LTD.) | |
| Fluorochemical surfactant 10 (Solid content: 3) | |
| (Modiper F210 from NOF Corp.) | |
| Melamine resin | 5 |
| (SUPER BEKKAMIN G-821-60 from Dainippon Ink & Chemi- | |
| cals, Inc.) | |
| Tetrahydrofuran | 180 |
| Cyclohexanone | 50 |

### Example 13

The procedure of preparation of the electrophotographic photoreceptor in Example 9 was repeated to prepare an electrophotographic photoreceptor except for replacing the protective layer coating liquid with the following CTL including a fluorine-containing resin coating liquid:

CTL including a fluorine-containing resin coating liquid

| | |
|---|---|
| Low-molecular-weight | 2 |
| charge transport material | |
| having the following formula: | |

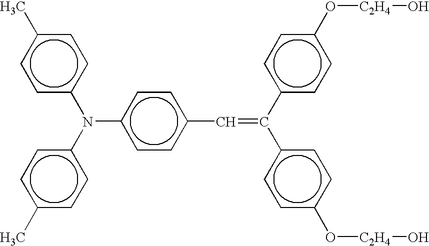

| | |
|---|---|
| Particulate fluorine-containing resin | 11 |
| (MPE-056 from DU PONT-MITSUI FLUOROCHEMICALS | |
| COMPANY, LTD.) | |
| Fluorochemical surfactant 14 (Solid content: 4.2) | |
| (Modiper F210 from NOF Corp.) | |
| Melamine resin | 5 |
| (SUPER BEKKAMIN G-821-60 from Dainippon Ink & Chemi- | |
| cals, Inc.) | |
| Tetrahydrofuran | 180 |
| Cyclohexanone | 50 |

A crosslinked resin in the CTL including a fluorine-containing resin in each Example 12 and Example 13 was crosslinked after heated at 150° C. for 30 min and dried.

The CTL including a fluorine-containing resin coating conditions in Examples 12 and 13 were as follows:

Coating liquid discharge amount: 15 ml/min

Coating liquid discharge pressure: 2.0 kgf/cm²

Rotation speed of the drum: 120 rpm

Coating speed: 24 mm/sec

Distance between spray head and drum: 5 cm

Number of coating: 2

Each of the thus prepared photoreceptors in Examples 12 and 13 was installed in a partially-modified electrophotographic image forming apparatus IPSiO Color 8100 from Ricoh Company, Ltd. to perform a running test wherein each consecutive 5 copies of a text image and a graphic image having a pixel density of 600 dpi×600 dpi, totally 20,000 copies of each image having an image area proportion of 5% were produced on copy papers TYPE 6000 from Ricoh Company, Ltd. 280 g of a developer including the a ferrite carrier coated with silicone, having an average particle diameter of 40 μm, and A toner in an amount of 5% by weight was used in each developing station unit of the electrophotographic image forming apparatus.

A charging roller located close to the electrophotographic photoreceptor was used as a charger for the electrophotographic image forming apparatus. A distance between the photoreceptor and charging roller was 50 μm.

The charging conditions were as follows:

Voltage of AC component: 1.5 kV (peak to peak voltage)

Frequency of AC component: 0.9 kHz

Voltage of DC component: DC voltage was controlled so that the charged photoreceptor has a potential of −700 V.

Development bias: −500 V

Environmental conditions: 24° C. 54% RH

The electrophotographic image forming apparatus did not have a discharger and the photoreceptor had a linear speed of 125 mm/sec, and a genuine cleaner thereof was used.

When the running test was finished, 10 copies of a halftone image having a pixel density of 1200 dpi×1200 dpi and an image area proportion of 5% were produced. Next, a surface of the photoreceptor the cleaning blade passed through was observed with a microscope to classify the cleanability into 5 grades. In addition, an abrasion amount and a friction coefficient of the surface thereof after the test were measured.

The results are shown in Table 6.

TABLE 6

| | | Binding between | | | |
|---|---|---|---|---|---|
| | Surface free | particulate | | | |
| | energy of | fluorine-con- | | | |
| | mixture of | taining resin | Abrasion | | |
| | binder resins | and mixture of | amount | Friction | Cleana- |
| | (mN/m) | binder resins (mN/m) | (μm) | coefficient | bility |
| Example 12 | 22.0 | 40.3 | 2.2 | 0.20 | 4 |
| Example 13 | 20.6 | 40.9 | 1.7 | 0.19 | 4 |

Examples 12 and 13 prove that a crosslinked resin used in the surface of a photoreceptor can elicit a high abrasion resistance thereof.

### Example 14

The procedure of preparation of the electrophotographic photoreceptor in Example 9 was repeated to prepare an electrophotographic photoreceptor except for changing the thickness of the protective layer from 5 μm to 1 μm.

### Example 15

The procedure of preparation of the electrophotographic photoreceptor in Example 9 was repeated to prepare an electrophotographic photoreceptor except for changing the thickness of the protective layer from 5 μm to 3 μm.

### Example 16

The procedure of preparation of the electrophotographic photoreceptor in Example 9 was repeated to prepare an electrophotographic photoreceptor except for changing the thickness of the protective layer from 5 μm to 7 μm.

### Example 17

The procedure of preparation of the electrophotographic photoreceptor in Example 9 was repeated to prepare an electrophotographic photoreceptor except for changing the thickness of the protective layer from 5 μm to 10 μm.

Each of the thus prepared photoreceptors in Examples 14 to 17 and 9 was installed in an electrophotographic image forming apparatus IPSiO Color 8100 from Ricoh Company, Ltd. to perform a running test wherein each consecutive 5 copies of a text image and a graphic image, totally 10,000 copies of each image having an image area proportion of 5% were produced on copy papers TYPE 6000 from Ricoh Company, Ltd.

The genuine toner was used, and the developer packed therewith as a developing unit was used. The charger installed therein was used.

The charging conditions were as follows:

Voltage of AC component: 1.5 kV (peak to peak voltage)

Frequency of AC component: 0.9 kHz

Voltage of DC component: DC voltage was controlled so that the charged photoreceptor has a potential of −700 V.

Development bias: −500 V

Environmental conditions: 24° C. 54% RH

The electrophotographic image forming apparatus did not have a discharger and the photoreceptor had a linear speed of 125 mm/sec, and a genuine cleaner thereof was used.

When the running test was finished, 100 copies of a black solid image and a halftone image having a pixel density of 1200 dpi×1200 dpi were continuously produced to classify residual images on the halftone images into the following 5 grades.

In addition, an irradiated part potential (VL) when a black solid image was produced such that a time between when the photoreceptor is irradiated and when the photoreceptor reaches the developing sleeve (irradiation-development time) was 125 msec and 70 msec was measured.

Residual Image

5: No residual image is observed.

4: A very minor degree of residual image is observed.

3: A minor degree of residual image is observed but the image is still acceptable.

2: Some degree of residual image is observed.

1: A considerable degree of residual image is observed and therefore the images have problem.

The results are shown in Table 7.

TABLE 7

| | Thickness of | | VL | VL |
|---|---|---|---|---|
| | the protective | Residual | (125 msec) | (70 msec) |
| | layer (μm) | image | (−V) | (−V) |
| Example 14 | 1 | 4 | 41 | 50 |
| Example 15 | 3 | 4 | 65 | 82 |
| Example 9 | 5 | 4 | 85 | 114 |
| Example 16 | 7 | 3 | 106 | 140 |
| Example 17 | 10 | 3 | 140 | 193 |

The irradiated part potential tends to rapidly increase as the thickness of the protective layer increases. Particularly when the irradiation-development speed is high, the irradiated part potential tends to increase more. When the protective layer has a thickness not less than 7 μm, the residual image tends to be much worse.

This proves that when the irradiation-development speed is about 70 msec, the protective layer preferably has a thickness not greater than 5 μm to produce high-quality images.

### Example 18

Each of the following undercoat layer coating liquid, a CGL coating liquid and a CTL coating liquid was coated on an aluminum cylinder with a diameter of 30 mm and then dried to overlay an undercoat layer having a thickness of 3.5 μm, a CGL having a thickness of 0.3 μm, and a CTL having a thickness of 22 μm. Next, the protective layer coating liquid was coated on the CTL with a spray to form a protective layer having a thickness of 5 μm thereon to prepare an electrophotographic photoreceptor of the present invention. The protective layer coating liquid was dispersed with a vibration mill using a zirconia ball having a diameter of 2 mm.

| | |
|---|---|
| Undcercoat layer coating liquid | |
| Alkyd resin | 10 |
| (BEKKOZOL 1307-60-EL from Dainippon Ink & Chemicals, Inc.) | |
| Melamine resin | 7 |
| (SUPER BEKKAMIN G-821-60 from Dainippon Ink & Chemicals, | |
| Inc.) | |
| Titanium dioxide | 40 |
| (CR-EL from Ishihara Sangyo Kaisha Ltd.) | |
| Methyl ethyl ketone | 200 |
| CGL coating liquid | |
| Bisazo pigment having the following formula: | 5 |
| (from Ricoh Company, Ltd.) | |

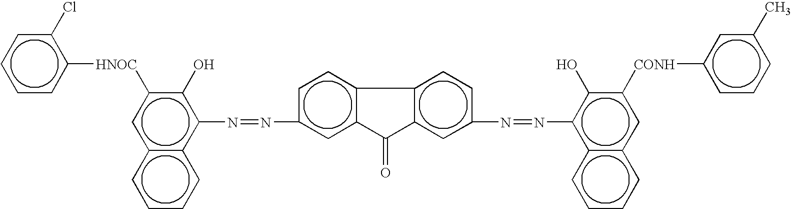

| | |
|---|---|
| Polyvinyl butyral | 1 |
| (XYHL from Union Carbide Corp.) | |
| Cyclohexanone | 200 |
| Methyl ethyl ketone | 80 |

CTL including a fluorine-containing resin coating liquid

| | |
|---|---|
| Polycarbonate resin | 10 |
| (Z-polyca from Teijin Chemicals Ltd. having a | |
| viscosity-average molecular weight of 50,000) | |
| Low-molecular-weight | 7 |
| charge transport material | |
| having the following formula: | |
| 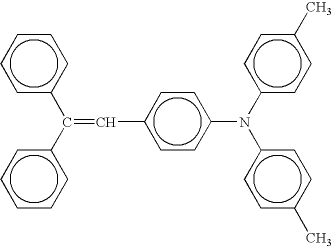 | |
| Tetrahydrofuran | 100 |
| 1% tetrahydrofuran solution of silicone oil 1 | |
| (KF50-100CS from Shin-Etsu Chemical Industry Co., Ltd.) | |

Protective Layer Coating Liquid

| | |
|---|---|
| Particulate fluorine-containing resin | 55 |
| (MPE-056 from DU PONT-MITSUI | |
| FLUOROCHEMICALS COMPANY, LTD.) | |
| Fluorochemical surfactant | 10 |
| (Modiper F210 from NOF Corp.) | (Solid content: 3) |
| Polyarylate | 42 |
| (U-polymer U-100 from Unitika, Ltd.) | |
| Tetrahydrofuran | 2,500 |
| Cyclohexanone | 700 |

### Example 19

The procedure of preparation of the electrophotographic photoreceptor in Example 9 was repeated to prepare an electrophotographic photoreceptor except for replacing the protective layer coating liquid with the following protective layer coating liquid:

Protective Layer Coating Liquid

| | |
|---|---|
| Particulate fluorine-containing resin | 55 |
| (MPE-056 from DU PONT-MITSUI | |
| FLUOROCHEMICALS COMPANY, LTD.) | |
| Fluorochemical surfactant | 10 |
| (Modiper F210 from NOF Corp.) | (Solid content: 3) |
| Polyester resin (O-PET from Kanebo, ltd.) | 42 |
| Tetrahydrofuran | 2,500 |
| Cyclohexanone | 700 |

### Example 20

The procedure of preparation of the electrophotographic photoreceptor in Example 9 was repeated to prepare an electrophotographic photoreceptor except for replacing the protective layer coating liquid with the following protective layer coating liquid:

Protective Layer Coating Liquid

| | |
|---|---|
| Particulate fluorine-containing resin | 55 |
| (MPE-056 from DU PONT-MITSUI | |
| FLUOROCHEMICALS COMPANY, LTD.) | |
| Fluorochemical surfactant | 10 |
| (Modiper F210 from NOF Corp.) | (Solid content: 3) |
| Polystyrene resin (Sanlex SAN-L | 42 |
| from Mitsubishi Monsanto Chemical Co.) | |
| Tetrahydrofuran | 2,500 |
| Cyclohexanone | 700 |

Each of the thus prepared photoreceptors in Examples 18 to 20 was installed in a partially-modified electrophotographic image forming apparatus IPSiO Color 8100 from Ricoh Company, Ltd. to perform a running test wherein each consecutive 5 copies of a text image and a graphic image having a pixel density of 600 dpi×600 dpi, totally 20,000 copies of each image having an image area proportion of 5% were produced on copy papers TYPE 6000 from Ricoh Company, Ltd. 280 g of a developer including the a ferrite carrier coated with silicone, having an average particle diameter of 40 μm, and A toner in an amount of 5% by weight was used in each developing station unit of the electrophotographic image forming apparatus.

A charging roller located close to the electrophotographic photoreceptor was used as a charger for the electrophotographic image forming apparatus. A distance between the photoreceptor and charging roller was 50 μm.

The charging conditions were as follows:

Voltage of AC component: 1.5 kV (peak to peak voltage)

Frequency of AC component: 0.9 kHz

Voltage of DC component: DC voltage was controlled so that the charged photoreceptor has a potential of −700 V.

Development bias: −500 V

Environmental conditions: 24° C. 54% RH

The electrophotographic image forming apparatus did not have a discharger and the photoreceptor had a linear speed of 125 mm/sec, and a genuine cleaner thereof was used. When the running test was finished, 10 copies of a halftone image having a pixel density of 1200 dpi×1200 dpi and an image area proportion of 5% were produced. Next, a surface of the photoreceptor the cleaning blade passed through was observed with a microscope to classify the cleanability into 5 grades. In addition, an abrasion amount of the surface thereof after the test was measured.

The results are shown in Table 8.

TABLE 8

| | | Binding between | | |
|---|---|---|---|---|
| | Surface free | particulate | | |
| | energy of | fluorine-con- | | |
| | mixture of | taining resin | Abrasion | |
| | binder resins | and mixture of | amount | Cleana- |
| | (mN/m) | binder resins (mN/m) | (μm) | bility |
| Example 18 | 22.6 | 40.8 | 3.9 | 4 |
| Example 19 | 21.2 | 42.2 | 4.1 | 4 |
| Example 20 | 19.3 | 41.0 | 5.0 | 4 |

The protective layer of Examples 18 to 20 included polyarylate, polyester and polystyrene as a binder resin respectively. Any of them had good cleanability. Each of Example 18 using polyarylate and Example 19 using polyester had a better abrasion resistance than that of Example 20 using polystyrene.

### Example 21

The electrophotographic photoreceptor prepared in Example 9 was installed in a cleanability tester. The cleanability tester includes a cleaning blade, an image developer and a photoreceptor drum, wherein the photoreceptor can be rotated at a random speed. The linear speed of the photoreceptor was 50 mm/sec. The image developer of IPSiO Color 8100 was used. The A toner was used. A contact angle between the photoreceptor and cleaning blade was 72°, and an interlocking amount therebetween was 1 mm. A stirring speed of the developer roll was 40 rpm and a developing bias was −500 V. The photoreceptor drum had a surface potential of −50 V. After a solid image was developed thereon, cleanability thereof was evaluated.

### Example 22

The procedure of evaluation of the cleanability of the photoreceptor in Example 21 was repeated except for changing the linear speed thereof to 100 mm/sec from 50 mm/sec.

### Example 23

The procedure of evaluation of the cleanability of the photoreceptor in Example 21 was repeated except for changing the linear speed thereof to 300 mm/sec from 50 mm/sec.

### Example 24

The procedure of evaluation of the cleanability of the photoreceptor in Example 21 was repeated except for changing the linear speed thereof to 500 mm/sec from 50 mm/sec.

### Example 25

The procedure of evaluation of the cleanability of the photoreceptor in Example 21 was repeated except for changing the linear speed thereof to 600 mm/sec from 50 mm/sec.

The results are shown in Table 9.

TABLE 9

| | Linear speed of | |
|---|---|---|
| | photoreceptor | cleanability |
| Example 21 | 50 | 2 |
| Example 22 | 100 | 4 |
| Example 23 | 300 | 4 |
| Example 24 | 500 | 4 |
| Example 25 | 600 | 3 |

The photoreceptor of the present invention has good cleanability when rotated at a linear speed of from 100 to 500 mm/sec.

An area ratio of a primary particle of the particulate fluorine-containing resin and a secondary particle thereof, which are projected from a surface of the outermost layer and have an average particle diameter of from 0.15 to 3 μm based on total surface area of an outermost layer thereof of each of the photoreceptors in Examples 1 to 20 was determined. The results are shown in Table 10.

TABLE 10

| | Area Ratio (%) |
|---|---|
| Example 1 | 12 |
| Example 2 | 14 |
| Example 3 | 14 |
| Example 4 | 14 |
| Example 5 | 14 |
| Example 6 | 14 |
| Example 7 | 14 |
| Example 8 | 16 |
| Example 9 | 14 |
| Example 10 | 14 |
| Example 11 | 14 |
| Example 12 | 14 |
| Example 13 | 14 |
| Example 14 | 14 |
| Example 15 | 14 |
| Example 16 | 14 |
| Example 17 | 14 |
| Example 18 | 14 |
| Example 19 | 14 |
| Example 20 | 14 |

This document claims priority and contains subject matter related to Japanese Patent Applications Nos. 2003-204333 and 2004-182287 filed on Jul. 31, 2003 and Jun. 21, 2004 respectively incorporated herein by reference.

Having now fully described the invention, it will be apparent to one of ordinary skill in the art that many changes and modifications can be made thereto without departing from the spirit and scope of the invention as set forth therein.

1. An electrophotographic photoreceptor comprising:
an electroconductive substrate;
a photosensitive layer located overlying the electroconductive substrate; and
optionally a protective layer located overlying the photosensitive layer,
wherein an outermost layer of the electrophotographic photoreceptor comprises:
a binder resin;
a particulate fluorine-containing resin in an amount of from 20 to 70% by volume based on total volume of the outermost layer, and
a fluorochemical surfactant in an amount of from 5 to 70% by weight based on total weight of the binder resin;
wherein a surface free energy of the particulate fluorine-containing resin is larger than a surface free energy of the binder resin.

2. The electrophotographic photoreceptor of claim 1, wherein the outermost layer comprises the particulate fluorine-containing resin in an amount of from 35 to 70% by volume based on total volume thereof.

3. The electrophotographic photoreceptor of claim 1, wherein the outermost layer is a layer selected from the group consisting of the protective layer, a charge transport layer of the photosensitive layer and the photosensitive layer.

4. The electrophotographic photoreceptor of claim 1, wherein the particulate fluorine-containing resin has a primary particle diameter of from 0.1 to 1 μm.

5. The electrophotographic photoreceptor of claim 1, wherein the particulate fluorine-containing resin is at least one resin selected from the group consisting of polytetrafluoroethylene, tetrafluoroethylene/perfluoroalkylvinylether copolymers and tetrafluoroethylene/hexafluoropropylene copolymers.

6. The electrophotographic photoreceptor of claim 1, wherein the fluorochemical surfactant is a copolymer or a block copolymer obtained from a methacrylate and a fluoroalkyl acrylate.

7. The electrophotographic photoreceptor of claim 1, wherein the binder resin comprises a resin selected from the group consisting of polycarbonate, polyester, polyarylate, and mixtures thereof.

8. The electrophotographic photoreceptor of claim 1, wherein the binder resin is a resin formed by a crosslinking reaction between a fluorochemical surfactant comprising a reactive hydroxyl group and a thermosetting resin monomer.

9. The electrophotographic photoreceptor of claim 11, wherein the thermosetting resin monomer is melamine.

10. The electrophotographic photoreceptor of claim 1, wherein the binder resin is a resin formed by a crosslinking reaction among a fluorochemical surfactant comprising a reactive hydroxyl group, a charge transport material comprising a reactive hydroxyl group and a thermosetting resin monomer.

11. The electrophotographic photoreceptor of claim 3, wherein the outermost layer is the charge transport layer, and wherein the charge transport layer comprises a charge transport polymer material.

12. The electrophotographic photoreceptor of claim 3, wherein the outermost layer is the photosensitive layer, and wherein the photosensitive layer comprises a charge transport polymer material.

13. The electrophotographic photoreceptor of claim 1, wherein the electrophotographic photoreceptor comprises a protective layer having a thickness of from 2 to 5 μm.

14. The electrophotographic photoreceptor of claim 3, wherein the outermost layer is a charge transport having a thickness of from 2 to 5 μm.

15. The electrophotographic photoreceptor of claim 3, wherein the outermost layer is a photosensitive layer having a thickness of from 2 to 5 μm.

16. The electrophotographic photoreceptor of claim 1, wherein particles of the particulate fluorine-containing resin, which are primary particles thereof or secondary particles formed of agglomerated primary particles thereof which have an average particle diameter of from 0.15 to 3 μm are projected from a surface of the outermost layer in an area ratio not less than 10% based on total surface area of the outermost layer.

17. A process cartridge comprising:
the electrophotographic photoreceptor according to claim 1; and
at least one member selected from the group consisting of chargers, irradiators, image developers, transferers and fixers.

18. An electrophotographic image forming apparatus comprising:
the electrophotographic photoreceptor according to claim 1;
a charger configured to charge the electrophotographic photoreceptor;
an image developer configured to develop an electrostatic latent image with a developer comprising a toner to form a toner image on the electrophotographic photoreceptor; and
a transferer configured to transfer the toner image onto a transfer sheet;
an irradiator configured to irradiate the electrophotographic photoreceptor to form the electrostatic latent image thereon; and
a fixer configured to fix the toner image on the transfer sheet.

19. The electrophotographic image forming apparatus of claim 18, wherein the electrophotographic photoreceptor has a linear speed of from 100 to 500 mm/sec.

20. The electrophotographic image forming apparatus of claim 18, further comprising a member configured to spread the particulate fluorine-containing resin projected from a surface of the electrophotographic photoreceptor while contacting thereto.

21. The electrophotographic image forming apparatus of claim 20, wherein the member applies a pressure of from 5 to 50 gf/cm to the surface of the electrophotographic photoreceptor.

22. The electrophotographic photoreceptor of claim 1, comprising a protective layer located overlying the photosensitive layer.

23. The electrophotographic photoreceptor of claim 1, further comprising an undercoat layer located between the electroconductive substrate and the photosensitive layer.

24. The electrophotographic photoreceptor of claim 23, wherein said undercoat layer comprises at least one resin selected from the group consisting of polyvinyl alcohol resins, casein, polyacrylic acid sodium salts, nylon copolymers, methoxymethylated nylon resins, polyurethane resins, melamine resins, alkyd-melamine resins, and epoxy resins.

25. The electrophotographic photoreceptor of claim 23, wherein said undercoat layer further comprises at least one metal oxide powder selected from the group consisting of titanium oxide, silica, alumina, zirconium oxide, tin oxide and indium oxide powders.
